(19) United States
(12) Patent Application Publication
(10) Pub. No.: US 2023/0367760 A1
(43) Pub. Date: Nov. 16, 2023

(54) POLICY-GUIDED DOMAIN ADAPTATION FOR ANOMALY DETECTION

(71) Applicant: Visa International Service Association, San Francisco, CA (US)

(72) Inventors: Kwei-Herng Lai, Houston, TX (US); Lan Wang, Urbana, IL (US); Huiyuan Chen, Cleveland, OH (US); Fei Wang, Fremont, CA (US); Hao Yang, San Jose, CA (US)

(21) Appl. No.: 17/742,966

(22) Filed: May 12, 2022

(51) Int. Cl. G06F 16/23; G06N 3/08

(52) U.S. Cl. CPC G06F 16/2365; G06N 3/08

(57) ABSTRACT

Embodiments are directed to novel techniques for performing domain adaptation on time series data. Using embodiments, labeled source time series data can be used in order to label unlabeled target time series data as either normal or anomalous. Embodiments can accomplish this using an anomaly detector system comprising an anomaly detector component and a context sampler component. The context sampler can determine source and target window sizes used to sample data from the source and target data sets respectively. These samples can be input into the anomaly detector, which can label a target data value corresponding to the target sample as normal or anomalous. The anomaly detector can additionally generate a state value, which can be used by the context sampler to adjust the source and target window sizes accordingly. In this way, embodiments can accurately and automatically perform domain adaptation.

### CROSS-REFERENCE TO RELATED APPLICATIONS

None.

### BACKGROUND

Domain adaptation can refer to a process in machine learning in which knowledge from a source domain is applied or adapted for use with a target domain. This knowledge can take the form of data labels corresponding to the source domain or a well-trained model corresponding to the source domain. As an example, using domain adaptation and a labeled source data set, labels can be generated for an unlabeled target data set.

Domain adaptation can be homogeneous or heterogeneous. Homogeneous domain adaptation relates to applications where the source domain and target domain are similar. For example, labeled health data corresponding to a first patient “Alice” can be used to label (previously unlabeled) health data corresponding to a second patient “Bob.” As an exemplary application, if Alice's health data values are labeled to identify disease precursors, domain adaptation can be used to generate similar labels for Bob's health data values, allowing the identification of risk factors of disease for Bob.

Heterogeneous domain adaptation relates to applications where the source domain and target domain are different. For example, labeled check transaction data can be used to generate labels for credit card transaction data. As an exemplary application, if the check transaction data values are labeled as normal or fraudulent, similar labels can be generated for the credit card transaction data values, enabling credit card companies or law enforcement agents to identify fraudulent credit card transactions.

Time series data is data for which each data element is associated with a particular time stamp or time value. Typically, such data is organized in a chronological series based on these time values. Often, in time series data analysis, groups, subseries, or “windows” of time series data may be evaluated together, rather than evaluating individual data elements. For example, when evaluating heart rate data, a 10 second window of heart rate data may be analyzed rather than a single heart rate measurement. As another example, when evaluating time series weather data, a window may comprise months or even years of data. There are a variety of reasons why analysts evaluate time series data in this way.

As one example, evaluating windows of data allows contextual information to be captured. A heart rate of 120 bpm is unusual at rest, but may not be unusual during a period of exercise. Evaluating multiple heart rates over, e.g., a 20 second window may reveal that the subject is exercising, and thus their heart rate is not unusual. Likewise, an outdoor temperature measurement of 32 degrees Fahrenheit may not be unusual on its own, but would be usual if it occurred in the middle of summer when the average outdoor temperature is 80 degrees Fahrenheit. Because context is often relevant, evaluating windows of data is sometimes preferable to evaluating individual data values.

As such, when evaluating time series data, window size can have an effect on the quality of the analysis. Analysts often use their domain expertise in order to set window sizes for the data they are analyzing, however, different data sets often benefit from different window sizes. Additionally, for many data sets, there is no currently known optimal method for determining the “correct” window size to use to evaluate that data set. This problem is compounded for domain adaptation of time series data, in which the source data set and target data set may benefit from unequally sized windows.

Embodiments address these and other problems, individually and collectively.

### SUMMARY

Embodiments of the present disclosure are directed to novel systems for performing domain adaptation on time series data, particularly relating to the field of anomaly detection. In summary, systems and methods according to embodiments can use labeled source time series data (in which source data values are labeled as normal or anomalous) in order to label target time series data values as normal or anomalous.

Whether a data value is normal or anomalous depends on the nature of the data being evaluated and the particular purpose for which it is being evaluated. For example, for medical data such as a patient's body temperature, a normal data value might correspond to a temperature reading close to 98.6 degrees Fahrenheit, while an anomalous data value might correspond to a temperature reading greater than 100 degrees Fahrenheit or less than 95 degrees Fahrenheit. For data related to credit card transactions, a fraudulent credit card transaction may be labeled anomalous, while a legitimate credit card transaction may be labeled normal.

Embodiments can accomplish this using an anomaly detector system comprising at least two parts. The first is an “anomaly detector” (also referred to as an “anomaly detector component,” not to be confused with the entire anomaly detector system). The second is a “context sampler.” During a training phase, in broad terms, the anomaly detector system uses a labeled source data set and an unlabeled target data set to learn how to classify data values as normal or anomalous. During an anomaly detection phase, the trained anomaly detector system can classify one or more unlabeled target time series data values in the target data set as normal or anomalous. The anomaly detector system can comprise a computer system, and the anomaly detector component and context sampler component can be implemented as one or more software application or modules operating on that computer system.

As described above in the Background, sampling window size can have an effect when evaluating time series data. As described further below with reference to FIG. 1, all other things being equal (or sufficiently similar), two anomaly detector systems presented with differently sized windows of data may produce different classifications and may have different anomaly detection rates.

Conventionally, a human domain expert uses their expertise to pick a particular window size for the particular time series data they are analyzing. This window size is usually static, and may be consistent across multiple data domains. For example, a source data set and target data set may be subject to the same window size. This procedure can reduce the overall accuracy of time series data analysis, particularly domain adaptation, as the source and target domains may benefit from differently sized windows. Additionally, as shown below with reference to FIG. 1, different datasets respond differently to different window sizes. It is difficult or impossible for a human domain expert to determine precisely, based only on their knowledge or expertise, what window size will achieve the best performance.

By contrast, embodiments of the present disclosure use a context sampler component to automatically determine optimal window sizes for the source and target data. This eliminates the need for a domain expert, and also improves classification accuracy, as evidenced by the experimental data presented in FIGS. 12 and 13. In broad terms, during the training phase, the context sampler evaluates the performance of the anomaly detector, and learns how to produce source window sizes and target window sizes that lead to better anomaly detector performance. During the anomaly detection phase, the context sampler can determine source and target window sizes which can be used to sample data from the source data set and target data set, enabling the anomaly detector component to accurately classify data values in the target data set as normal or anomalous.

As such, one embodiment is directed to a method comprising: a) generating, by a computer system, an initial source window size and an initial target window size; b) sampling, by the computer system, one or more initial source time series data values and one or more initial target time series data values using the initial source window size and the initial target window size; c) generating, by the computer system a state value using the one or more initial source time series data values and the one or more initial target time series data values; and d) for each time value up to a training epoch value, performing the following steps: (i), generating, by the computer system using a context sampler, an action comprising a source window size and a target window size based on the state value; (ii) sampling, by the computer system, one or more source time series data values based on the source window size and the time value; (iii) sampling, by the computer system, one or more target time series data values based on the target window size and the time value; (iv) updating, by the computer system, the state value to an updated state value using the one or more source time series data values and the one or more target time series data values; (v) computing, by the computer system, a reward value using an anomaly detector, the one or more source time series data values, and the one or more target time series data values; (vi) storing, by the computer system, a tuple including the state value, the action comprising the source window size and the target window size, the updated state value, and the reward value in a memory buffer of the context sampler; and (vii) training by the computer system, the context sampler in an iterative process using sampled data from the memory buffer of the context sampler.

Another embodiment is directed to a computer system comprising a processor and a non-transitory computer readable medium coupled to the processor, the non-transitory computer readable medium comprising code, executable by the processor for performing the method above.

Another embodiment is directed to a method for labeling a target data value as being normal or anomalous using a plurality of source time series data values in a source data set, the method comprising: obtaining, by a computer system, a source data set and a target data set, wherein the source data set comprises the plurality of source time series data values, and wherein the target data set comprises a plurality of target time series data values, wherein the plurality of source time series data values are labeled and the plurality of target time series data values are unlabeled; setting, by a trained context sampler in the computer system, an initial source window size and an initial target window size; sampling, by the computer system, one or more source time series data values from the source data set using the initial source window size and based on a time value; sampling, by the computer system, one or more target time series data values from the target data set using the initial target window size and based on the time value; providing, by the computer system, the one or more source time series data values and the one or more target time series data values to an anomaly detector; and determining, by the computer system, using the anomaly detector, whether the target data value comprises an anomalous data value.

These and other embodiments of the disclosure are described in more detail in the detailed description below.

### TERMS

A “server computer” may include a powerful computer or cluster of computers. For example, the server computer can include a large mainframe, a minicomputer cluster, or a group of servers functioning as a unit. In one example, a server computer can include a database server coupled to a web server. The server computer may comprise one or more computational apparatuses and may use any of a variety of computing structures, arrangements, and compilations for servicing the requests for one or more client computers.

A “memory” may include any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation. A “memory buffer” can include a region of memory used to temporarily store data.

A “processor” may include any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or XScale; and/or the like processor(s).

A “data set” may include any set of one or more “data values.” A “data value” can include any data element or observation. A data value can comprise a “data vector,” one or more values (represented in vector form) corresponding to a data element or observation. A “time series data value” may include any data value corresponding to time series data. Time series data may comprise data for which each data value has an associated “time value,” “time stamp,” or “time indicator.” A “time value” can represent or correspond to the time at which the corresponding data value was observed or collected. Time series data is often ordered chronologically based on time values.

“Domain adaptation” may include any method or process by which data, information, or knowledge corresponding to a first data set is used or “transferred” to a second data set. In some cases, the first data set may be referred to as a “source data set” and the second data set may be referred to as a “target data set.” Domain adaptation can comprise, for example, using label information from a labeled source data set to generate labels for a target data set. For example, labeled heartrate data (e.g., indicating cardiac events such as myocardial infarction, arrhythmia, etc.), corresponding to a source data set, can be used to generate labels for unlabeled heartrate data corresponding to a target data set.

The process of “training” a machine learning model may include any steps used to prepare a machine learning model to perform some task, such as anomaly detection. Often training involves determining or optimizing a set of “parameters” (which characterize the machine learning model) which result in acceptable model performance.

“Anomaly detection” may include any process or method used to detect “anomalies.” For example, anomaly detection can be used to detect anomalous data values in a data set. An “anomaly” may include anything that deviates from what is standard, normal, or expected. For example, an anomalous data value can be an outlier in a data set. An anomalous data value can correspond to a particular anomalous event. For example, for heartrate data, an anomaly can comprise a data value corresponding to a cardiac episode, e.g., myocardial infarction. An “anomaly score” may include any value generated during an anomaly detection process. An anomaly score can indicate the likelihood that a data value comprises an anomaly. For example, an anomaly score of “0.81” can indicate that there is a 81° A chance that a data value is an anomalous data value.

A “classifier” may include something that produces “classifications.” A “classification” may include any category into which something can be assigned. For example, indicating that a data value is an anomalous data value can qualify as a classification of that data value. A classifier can be implemented using a machine learning model, which can take a data value as an input and produce a classification as an output, e.g., indicating whether the data value comprises an anomalous data value.

“Sampling” may include any process or method used to collect data values. Sampling can be used to collect data values from an existing data set. The act of sampling may result in a “sample,” one or more data values collected from the data set during sampling. Data sets can be sampled via a variety of means. For example, “random sampling” involves sampling data values from a data set randomly. A “window” or “window of data” may include any number of contiguous data elements from a data set. A “window” may be defined by a starting data value and an ending data value, such that the window contains all data values between the starting data value and ending data value (and optionally the starting data value and ending data values themselves). “Window sampling” can be used to sample data values contained within a window of data.

An “encoder” may include any function, device, or method used to produce encodings from input data. An “encoding” may include any representation of the input data. Often, encodings comprise less data than the input data used to produce the encoding. A “decoder” may include any function, device, or method used to produce input data from encodings. The data produced by a decoder may be referred to as a “reconstruction.” Sometimes, reconstructions do not perfectly match the input data used to produce the encoding. Encoders and decoders can be implemented using a Long Shorter Term Memory autoencoder (LSTM autoencoder), a type of machine learning model.

A “loss value” or “error value” may include any value that indicates the deviation between a result of some process, method, or function and an expected, desired, or correct result. For example, if a machine learning model can detect anomalies in a data set comprising 100 data values, 17 of which are anomalous, if the machine learning model only detects 15 the 17 anomalous data values, the loss value could comprises, e.g., 2 (17-15). Loss values can be used to train and evaluate the training of machine learning models, e.g., by optimizing machine learning model parameters by minimizing the loss value.

A “tuple” may include any finite ordered list of elements. For example, a list comprising three elements (Name: “John”, Age: “30”, Weight: “160”) can comprise a tuple. Tuples can be used for a variety of purposes, including machine learning. A tuple used to train a machine learning model can be referred to as a “training tuple.”

A “Markov decision process” (MDP) can include a model for decision making by a decision maker (e.g., a computer system). Many decision making problems can be modeled as MDPs. In an MDP, the current “state” of the decision maker can be represented by a “state value.” The decision maker can take “actions” to change their state to a new state, represented by a new state value. Some actions are associated with “rewards,” represented by “reward values.” The reward values indicate which actions are preferable for the decision maker to make.

A “policy” can include any course or principle of action adopted by an entity. A “policy function” may be used to carry out a particular policy by a computer or other device. In the context of MDPs, a policy function may be used to determine an action that result in the highest cumulative reward given a current state of the of the decision maker.

A “hyper-parameter” can include any value used to configure a machine learning model that is external to the machine learning model. Typically, a hyper-parameter cannot be estimated from the data that is used to train the machine learning model. Hyper-parameters can be used, for example, when combining the outputs of two different machine learning models to produce a single output.

### BRIEF DESCRIPTION OF THE DRAWINGS

FIG. 1 shows a table detailing the effect of window size on anomaly detection rate for different data sets.

FIG. 2 shows an overview summarizing some methods according to embodiments.

FIG. 3 shows an exemplary computer system that can be used to perform some methods according to embodiments.

FIG. 4 shows a system block diagram, detailing some operations performed by an anomaly detector component during a training phase.

FIG. 5 shows a system block diagram, detailing some operations performed by a loss and reward calculator during a training phase.

FIG. 6 shows a system block diagram, detailing some operations performed by a context sampler during a training phase.

FIGS. 7A-7B show a flowchart comprising steps performed by a computer system during a training phase.

FIG. 8 shows pseudocode corresponding to a training method according to some embodiments.

FIG. 9 shows a system block diagram, detailing some operations performed by an anomaly detector component during an anomaly detection phase.

FIG. 10 shows a system block diagram, detailing some operations performed by a context sampler during an anomaly detection phase.

FIG. 11 shows a flowchart comprising steps performed by an computer system during an anomaly detection phase.

FIG. 12 shows a table summarizing the results of a homogeneous domain adaptation experiment according to some embodiments.

FIG. 13 shows a table summarizing the results of a heterogeneous domain adaptation experiment, as well as a table summarizing some statistics of the data sets used for the homogeneous and heterogeneous domain adaptation experiments.

### DETAILED DESCRIPTION

As described above, embodiments of the present disclosure are directed to an anomaly detection system, which can be implemented using a computer system. Occasionally, the anomaly detector system may be referred to using the proper noun “ContexTDA.” The anomaly detection system can perform time series domain adaptation on a source data set (typically represented by X) and a target data set (typically represented by \hat{X}). More specifically, during the training phase, the anomaly detector system can use labeled source data values (typically represented by xₜ) and unlabeled target data values (typically represented by \hat{x}ₜ) to learn to classify data values as normal or anomalous. During the anomaly detection phase, the trained anomaly detector system can label one or more target data values as normal or anomalous. As described above, the anomaly detector system can comprise an anomaly detector component and a context sampler component.

Detecting anomalies in time series data can be challenging due to limited access to label information and complex dependencies between individual time data values. Time series anomaly detection has a wide variety of applications in various domains such as intrusion detection for web servers [Kim et al., IEEE Access, 8:70245-70261, 2020], predictive maintenance for manufacturing lines [Hsu and Liu, Journal of Intelligent Manufacturing, 32:823-836, 2021], fault detection for monitoring systems [MacEachern and Vazhbakht, In 2020 IEEE 63rd International Midwest Symposium on Circuits and Systems (MWSCAS), pages 142-145. IEEE, 2020], and fraud detection for financial transactions [Hashedi and Magalingam, Computer Science Review, 40:100402, 202]. The underlying technique of these applications involves modeling major data distribution in an unsupervised fashion using deep autoencoders [Baldi, In Proceedings of ICML workshop on unsupervised and transfer learning, pages 37-49. JMLR Workshop and Conference Proceedings, 2012; Mayu Sakurada and Takehisa Yairi, In Proceedings of the MLSDA 2014 2nd Workshop on Machine Learning for Sensory Data Analysis, pages 4-11, 2014] and identifying data points that deviates from the majority as anomalies.

Nevertheless, training a deep anomaly detector with limited label information can lead to sub-optimal performance. Therefore, increasing research efforts are devoted into time series domain adaptation to exploit data from similar domains. Domain discrepancy minimization techniques [Cai et al., arXiv preprint arXiv: 2012.11797, 2020] involve mapping subsequences of two domains into same subspace and minimizes metric distances between the mapped data points for knowledge transfer. Domain discrimination [Jin et al., arXiv preprint arXiv: 2102.06828, 2021; Du et al., In Proceedings of the 30th ACM International Conference on Information & Knowledge Management, pages 402-411, 2021] involves extracting domain invariant features from subsequences of two domains by performing adversarial training on a domain discriminator and feature generator.

Although some techniques are capable of transferring knowledge between two domains with unified context windows, these techniques may lead to negative anomaly knowledge transfers because the context information used to identify anomalies in the two domains may be very different. However, aligning context windows of two different domains with different context window sizes can lead to improved anomaly detection. Some embodiments can apply multiple context window sizes for the target domain while applying a fixed source domain window size during anomaly detection. Systems according to embodiments can train an anomaly detector for both domains in different context window settings and minimize domain discrepancies between the two domains, in order to adapt source domain information to the target domain, enabling the detection of anomalous data values within a target data set X.

However, it is non-trivial to develop embodiments due to two challenges. First, temporal dependencies within each domain and the correlations between two domains are complex, and it is challenging to simultaneously model two different types of information. For example, each machine in the server machine dataset (SMD) [Hundman et al., In Proceedings of the 24th ACM SIGKDD international conference on knowledge discovery& data mining, pages 387-395, 2018] has 38 dimensions, and modeling the dependencies between each dimension and corresponding time points is already challenging, ignoring the difficulty of evaluating two machines at the same time. Second, anomalies from different domains behave differently, and it is challenging to extract beneficial information for target domain anomaly detection. For instance, anomalies from machine 1-1 of SMD dataset comprise extreme values that can be detected with a trivial threshold; while anomalies from machine 1-2 are implicit and hard to detect. It is difficult to leverage label information of 1-1 for detecting anomalies in 1-2.

To address the challenges, some embodiments of the present disclosure include a context-aware domain adaptation system that can select context window sizes used to perform time series domain adaptation for anomaly detection. Specifically, embodiments formulate the time series context sampling problem of domain adaptation into a Markov decision process (MDP). To solve the MDP, embodiments employ deep Q-learning (DQN) techniques with a tailored reward function. The reward function is designed to learn the optimal context window sampling strategy for knowledge transference between a source data set and a target data set and effectively exploit label information in order to perform anomaly detection.

As implied by the description above, systems and methods according to embodiments make use of a variety of concepts, including time series anomaly detection, time series domain adaptation, deep reinforcement learning, encoding, decoding, Markov decision processes (MDP), etc. As such, it may be helpful to summarize these concepts prior to describing embodiments of the present disclosure in more detail.

As described above, domain-adaptation generally refers to a process by which knowledge from a first domain, such as a source data set X, can be applied or used in a second domain, such as a target data set \hat{X}. In embodiments, a labeled source time series data set X (comprising a plurality of source time series data values) can be used to train an anomaly detector system to detect anomalies, or otherwise classify a plurality of target time series data values in an unlabeled source time series data set \hat{X}. This could be useful, for example, if label information is easier to acquire for the source data set X than the target data set \hat{X}.

Embodiments of the present disclosure could be used, for example, to use credit card transaction data (source data, labeled to identify credit card transactions as normal or anomalous (i.e., fraudulent)) to train an anomaly detector system to detect anomalies in unlabeled check transaction data (target data). As another example, labeled source health data corresponding to a first person (e.g., the subject of extensive medical research) could be used to train an anomaly detector system to detect health anomalies in unlabeled target data corresponding to a patient (who may not be the subject of extensive medical research).

In summary, machine-learned anomaly detection generally involves two phases, which may be referred to as the training phase and an anomaly detection phase. In broad terms, during the training phase, an anomaly detector system “learns” the features of normal and anomalous data values. During the anomaly detection phase, the trained anomaly detector system takes data values as inputs and determines whether those data values are normal or anomalous.

As an aside, the term “data value” is used throughout this disclosure. This term is generally meant to refer to one “element” or observation of data, and not necessarily a single numerical value. For example, a data vector or array corresponding to heartrate data, comprising multiple values such as [Name: Alice, Age: 28, BPM: 100, Time: 217] may, for convenience, be referred to as a data value. Such a data value may be “labeled” indicating whether the data value is a normal data value or an anomalous data value (e.g., corresponding to an unusually high or low BPM). Time series data values may comprise data values corresponding to time series data. In embodiments, a source data set may comprise a plurality of source time series data values, which may be labeled. Likewise, a target data set may comprise a plurality of target time series data values, which may be unlabeled.

When analyzing time series data, it may be advantageous to analyze representative samples of data, rather than single data values. For example, when classifying the target time series data value \hat{x}₁₀ as normal or anomalous, it may be preferable for the anomaly detector system to use a representative sample of data values (i.e., one or more target time series data values) in order to perform this classification. For example, in order to classify the target time series data value \hat{x}₁₀, a representative sequence such as (\hat{x}₇, \hat{x}₈, \hat{x}₉, \hat{x}₁₀) or (\hat{x}₅, \hat{x}₆, \hat{x}₇, \hat{x}₈, \hat{x}₉, \hat{x}₁₀) may be input into the anomaly detector system.

The term “window size” may refer to some value used to define the number of data values or other elements in a sequence. For example, the sequence (\hat{x}₇, \hat{x}₈, \hat{x}₉, \hat{x}₁₀) may have a window size of 4, while the sequence (\hat{x}₅, \hat{x}₆, \hat{x}₇, \hat{x}₈, \hat{x}₉, \hat{x}₁₀) may have a window size of 6. Window sizes can also be expressed in different ways, a window size of “10 seconds” may define a subsequence of data values corresponding to a 10 second period of time.

As stated above, changing the window size often has an effect on the accuracy of anomaly detector systems. Furthermore, different data sets may benefit from different window sizes. For example, a data set corresponding to a long term trend may benefit from a larger window size, while a data set corresponding to a short term trend may benefit from a smaller window size. For the long term trend, using too small of a window size may leave out important contextual information or may make the anomaly detector system responsive to transient noise. For the short term trend, using too large of a window size may make the anomaly detector system too responsive to irrelevant data. Conventionally, a domain expert picks a particular, fixed window size, which is used over the entirety of the training phase and anomaly detection phase.

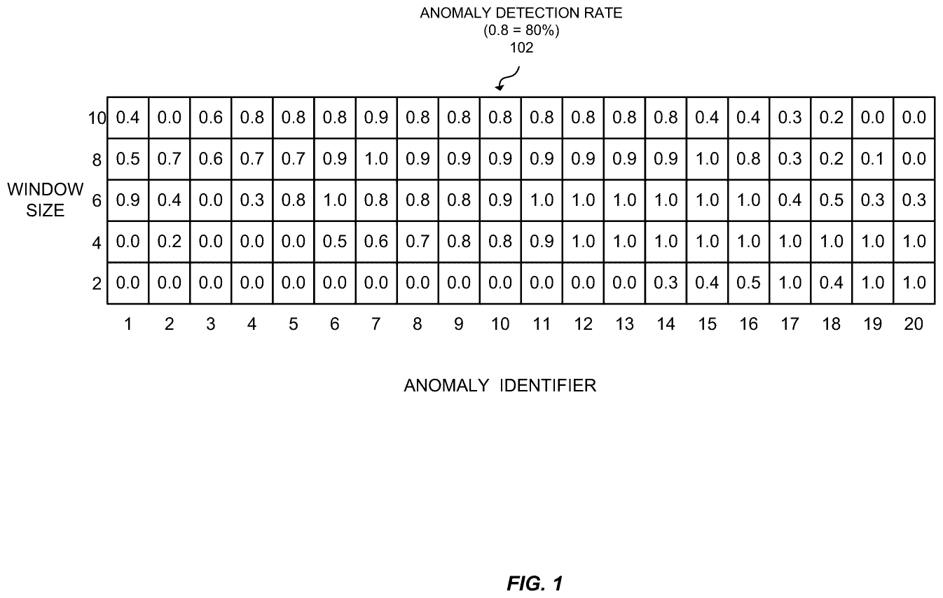

The difficulty associated with selecting window sizes for time series data evaluations, particularly anomaly detection, is illustrated by the table presented in FIG. 1. Anomaly detection was performed over 20 runs of 20 randomly selected anomalies from the server machine dataset (SMD). These anomalies are indicated by anomaly indicators 1-20. Each set of runs was performed at five different window sizes: 2, 4, 6, 8, and 10. Anomaly detection rates (such as anomaly detection rate 102) corresponding to each data set and window size pair are presented in the table of FIG. 1. Anomaly detection rates of between 0.0 and 1.0 indicate that between 0% and 100% of anomalies in that data set were detected. For example, anomaly detection rate 102 indicates that 80% of anomalies were detected in data set 10 with a window size of 10.

FIG. 1 illustrates how a particular window size can have a large effect on anomaly detection rates. Specifically, FIG. 1 shows the effect of different context window sizes for target domain data on 20 randomly selected anomalies from the SMD dataset (server machine dataset) (see below for a description). The X-axis corresponds to anomaly identifiers 1-20, and Y-axis corresponds to the context window size. The numbers represent the detection ratio using 20 different random seeds.

With respect to anomaly 18, for example, a 100% detection rate can be achieved with a window size of 4, which is twice as much as the next best detection rate (50%) at a window size of 6. In addition, the relationship between window size and anomaly detection rate changes depending on the anomalous data value being evaluated. A window size of 4 corresponds to the best detection rate for anomaly 18, but corresponds to the worst detection rate for anomaly 1. FIG. 1 thus illustrates how window size influences anomaly detection rates.

As described in more detail further below, an anomaly detection system according to embodiments makes use of both an anomaly detector component and a context sampler component. During training, the anomaly detector can learn, broadly, how to classify time series data values (which can be characterized or represented by sequences of data values) as normal or anomalous. At the same time, the context sampler can learn what window sizes result in the best anomaly detection performance (e.g., the highest anomaly detection rate). This has at least two advantages over the conventional method of setting a static window size using a domain expert. The first is an improvement to the accuracy of the anomaly detector system, the second is enabling window sizes to be determined automatically, eliminating the need for a domain expert.

Encoding and decoding are two concepts that may be useful to understanding embodiments of the present disclosure. In embodiments of the present disclosure, an encoder ε and a decoder [symbol] can be implemented using a Long short-term memory (LSTM) autoencoder.

An encoder ε generally takes some data as an input (e.g., one or more time series data values) and produces an encoding. For example, an encoding of one or more source time series data values xₜ may be referred to as a “source encoding” and may be represented by the expression ε(xₜ). Likewise, an encoding of one or more target time series data values \hat{x}ₜ may be referred to as a “target encoding” and may be represented by the expression ε(\hat{x}ₜ). An encoding can comprise some data that is representative of the input data. Often encodings are of fixed length, meaning that regardless of the size of the input data, the encoding always comprises the same amount of data, which is often less data than the input data. For example, an encoder ε may take 100 MB of data as an input, and produce a 10 MB encoding, or take 200 MB of data as an input, and still produce a 10 MB encoding.

A decoder [symbol] generally takes an encoding as input, and generates (or attempts to generate) the original data used to produce that encoding (e.g., one or more time series data values). The output of a decoder [symbol] may be referred to as a “reconstruction” of the input data. For example, a reconstruction produced using a source encoding ε(xₜ) may be referred to as a “source reconstruction” and may be represented by the expression [symbol] (ε(xₜ)), while a reconstruction produced using a target encoding ε(\hat{x}ₜ) may be referred to as a “target reconstruction” and may be represented by the expression [symbol] (ε(\hat{x}ₜ). Sometimes the reconstruction of the input data is not a perfect reconstruction, i.e., exactly identical to the input data used to produce the encoding. This may be because of information loss resulting from the encoding being a smaller size than the input data. It may also result from imperfections in the encoder ε or decoder [symbol] itself.

Still, assuming that the encoder ε produces encodings that are good representations of the input data, and that the decoder [symbol] can generate reconstructions that are similar to the input data, encoders and decoders can be effective tools for machine learning applications. Encodings can be used to compare two sets or sequences of data, even if those sets or sequences comprise different amounts of data, because the encodings of those sequences (provided they were generated by the same fixed length encoder) can comprise the same amount of data.

For example, as described further below, embodiments of the present disclosure can use an alignment loss value [symbol] _{align} in order to calculate a reward value rₜ which can be used to train the anomaly detector system. The alignment loss value [symbol] _{align} can be calculated using the difference between a source encoding ε(xₜ) and a target encoding ε(\hat{x}ₜ), which is a method of comparing a source sample xₜ and a target sample \hat{x}ₜ, even if those two samples comprise a different number of time series data values, as shown in the formula presented below:

$${{ℒ}_{align} = {\sum }_{{x}_{t} ∈ {X}^{+} , {\hat{x}}_{t} ∈ \hat{X}} ‖ ℰ ( {x}_{t} ) - ℰ ( {\hat{x}}_{t} ) ) ‖}_{2}^{2}$$

As another example, as described further below, embodiments of the present disclosure can use an anomaly classifier [symbol] to classify one or more target time series data values \hat{x}ₜ as normal or anomalous. However, instead of classifying such samples directly (e.g., inputting a sample \hat{x}ₜ directly into the classifier [symbol] , i.e., [symbol] (\hat{x}ₜ), encodings of these samples can be classified instead, i.e., [symbol] (ε(\hat{x}ₜ)), as shown in the anomaly score formula presented below:

A(\hat{x}ₜ)= [symbol] (ε(\hat{x}ₜ))·∥\hat{x}ₜ− [symbol] (ε(\hat{x}ₜ))∥₂²

Provided that an encoding ε(\hat{x}ₜ) is a good representation of the encoded data \hat{x}ₜ the classification [symbol] (ε(\hat{x}ₜ)) should generally be accurate, e.g., produce a classification comparable to classifying the data itself. Further, the number of time series data values in the encoded data \hat{x}ₜ may depend on a window size used to sample the encoded data \hat{x}ₜ. However, the classifier [symbol] may require or benefit from an input of a particular size, or may have an upper limit on input sizes, hence a fixed length encoding ε(\hat{x}ₜ) may be a more effective input.

Embodiments of the present disclosure model the task of selecting source and target window sizes (used to sample data from the source data set and target data set), performed by the context sampler component as a Markov Decision Process (MDP). In the training phase, the context sampler component learns a policy \tilde{π} that enables the context sampler component to select optimal source and target window sizes, i.e., source and target window sizes that result in good anomaly detection rates, as described above with reference to FIG. 1. In the anomaly detection phase, the context sampler component can use the learned policy \tilde{π} to sample data from the source data set X and target data set \hat{X}, in order to enable the anomaly detector component to classify target time series data values as normal or anomalous.

In broad terms, an MDP is a process used to model decisions by a decision maker, e.g., the context sampler. The MDP is generally characterized by three things: state values, actions, and reward values. A state value sₜ generally comprises some value that characterizes or otherwise describes the current state of the decision maker. The decision maker can take actions aₜ, which cause the decision maker to move to a new state, changing the state value (e.g., to sₜ₊₁) as a consequence. Some actions have associated rewards, characterized by reward values rₜ.

Generally, higher reward values rₜ are associated with actions aₜ that are preferable for the decision maker to make, while lower reward values rₜ are associated with actions aₜ that are less preferable for the decision maker to make. The goal of many MDP application is to determine a policy \tilde{π} that enables the decision maker to determine the “optimal action” based on the current state value sₜ. This optimal action is not necessarily the action that produces the highest immediate reward value rₜ, but the action that produces the highest cumulative expected reward over time.

In more technical terms, Markov decision processes model sequential decision making processes which can be defined by a quintuple ( [symbol] , [symbol] , [symbol] _{T}T, [symbol] , γ), where [symbol] is a finite set of states, [symbol] is a finite set of actions, [symbol] _{T}: [symbol] × [symbol] × [symbol] → [symbol] ⁺ is the state transition probability function that maps the current state s, action a and the next state s′ to a probability value, [symbol] : [symbol] → [symbol] is the immediate reward function that reflects the quality of action a, and γ∈(0,1) is a discount factor. At each timestep t, the agent can take action aₜ∈ [symbol] based on the current state sₜ∈ [symbol] , and observes the next state sₜ₊₁ as well as a reward signal rₜ= [symbol] (sₜ₊₁ ). The agent's goal can be to determine an optimal series of actions such that the expected discounted cumulative reward is maximized. Mathematically speaking, the MDP can be used to determine a policy π: [symbol] → [symbol] that maximizes [symbol] _{π}[Σₜ₌₀^{∞}γ^{t}rₜ].

Deep reinforcement learning methods can be designed to solve MDPs with deep neural networks. Embodiments can use model-free deep reinforcement learning, which can learn the decision function during exploration. Deep-Q Learning (DQN) [Mnih et al. Nature, 518(7540):529, 2015] is a technique that uses deep neural networks to approximate state-action values Q(s, a) that satisfy:

$$Q ( s , a ) = {𝔼}_{{s}^{′}} [ ℛ ( {s}^{′} ) + γ {max}_{{a}^{′}} ( Q ( {s}^{′} , {a}^{′} ) ]$$

Where s′ is the next state and a′ is the next action. DQN introduces two techniques to stabilize the training process: (1) a replay buffer (or “memory buffer”) to reuse past experiences; (2) a separate target network that is periodically updated. Embodiments can employ a DQN as part of a context sampler component used to solve the MDP; embodiments can alternatively use advanced algorithms such as soft actor-critic [Haarnoja et al., In International conference on machine learning, pages 1861-1870. PMLR, 2018].

As described in more detail further below, in embodiments of the present disclosure, the state value sₜ may comprise a combination of a source encoding ε(xₜ) and a target encoding ε(\hat{x}ₜ). The source encoding ε(xₜ) may be generated using one or more source time series data values xₜ sampled from a source data set X. Likewise, the target encoding ε(\hat{x}ₜ) may be generated using one or more target time series data values \hat{x}ₜ sampled from a target data set \hat{X}. In some embodiments, the state value sₜ may comprise a concatenation of the source encoding ε(xₜ) and target encoding ε(\hat{x}ₜ), i.e., sₜ=(ε(xₜ), ε(\hat{x}ₜ)).

The action aₜ can comprise a source window size and a target window size. As described above, a policy \tilde{π}, learned during a training phase can be used to map state values sₜ to actions aₜ based on reward values rₜ (described in further detail below). These source and target window sizes can be used to sample a new set of one or more source time series data values xₜ₊₁ and a new set of one or more target time series data values \hat{x}ₜ₊₁, which can be used to generate a new source encoding ε(xₜ₊₁) and a new target encoding ε(\hat{x}ₜ₊₁), which can be used to generate a new state sₜ₊₁=(ε(xₜ₊₁), ε(\hat{x}ₜ₊₁)).

In more detail, the state sₜ∈ [symbol] in timestep t can be defined as a 2n dimensional vector (ε(xₜ), ε(\hat{x}ₜ), which can comprise the concatenation of the n-dimensional final hidden state generated by the encoder ε of the LSTM anomaly detector based on a current source data value xₜ and target data value \hat{x}ₜ. The action aₜ∈ [symbol] in timestep t can comprise a two-dimensional vector, the first and second dimensions comprising the source window size and target window size respectively. The action space for the source and target domains can range from 1 to a given maximum window size. The reward rₜ in timestep t can be defined as a combinatorial signal of source domain classification loss, source and target domain reconstruction loss, domain alignment and discrimination loss.

As described in more detail below, this “loop,” from samples xₜ and \hat{x}ₜ, to encodings ε(xₜ ) and ε(\hat{x}ₜ), to state value sₜ, to an action aₜ, to new samples xₜ₊₁ and \hat{x}ₜ₊₁ can be repeated in the both the training phase and the anomaly detection phase in order to train the anomaly detector system to label target time series data values as normal or anomalous respectively.

As described in greater detail further below, reward values rₜ can comprise measurements related to the performance of the anomaly detector component. A higher reward value rₜ is associated with better anomaly detector performance (e.g., a greater anomaly detection rate). Consequently, the policy \tilde{π}, implemented by the context sampler component, can be optimized during the training phase to produce actions aₜ (comprising source window sizes and target window sizes) that produce the highest reward values. This in effect trains the context sampler component to produce source window sizes and target window sizes that improves the quality of anomaly detection during the anomaly detection phase.

Generally, the performance of a particular machine learning model can be evaluated using loss functions. Loss functions often relate the output of a machine learning model with the expected output of such a model. For example, for a labeled input xₜ, with label yₜ (e.g., with value yₜ=0 for a normal input xₜ and value yₜ=1 for anomalous input xₜ), a classifier [symbol] can be used to produce a classification [symbol] (xₜ) corresponding to that input. If the classifier [symbol] is perfectly accurate, the classification [symbol] (xₜ) may equal the label yₜ for any input xₜ. However, often in practice, the classification [symbol] (xₜ) equals yₜ for some values of xₜ and does not equal yₜ for some other values of xₜ.

In the example provided above, the expected output can comprise the label yₜ, while the actual output comprises the classification [symbol] (xₜ), for the sake of example, a simplistic loss function such as [symbol] (xₜ)= [symbol] (xₜ)−yₜ can be used to evaluate the performance of the classifier [symbol] . The result of this loss function can comprise a loss value, typically represented by [symbol] . When the loss value [symbol] is small, the machine learning model is producing outputs that are consistent with the expected output. When the loss value [symbol] is large, the machine learning model is producing outputs that are inconsistent with the expected output. The task of training a machine learning model such as a classifier [symbol] , can be framed in terms of optimizing the parameters of the machine learning model in order to minimize the loss function (or more rarely, maximize the loss function). This can be accomplished using techniques such as stochastic gradient descent.

Embodiments of the present disclosure can use up to four loss values to characterize the performance of the anomaly detector component. These four loss values can be combined to determine a reward value rₜ, which can be used to train the anomaly detector and the context sampler. These four reward values are described below, however, before describing these reward values, it may be useful to briefly describe the anomaly detector component.

The anomaly detector component can comprise an LSTM autoencoder comprising an encoder ε and a decoder [symbol] . As stated above, the encoder ε can be used to generate source encodings and target encodings, while the decoder [symbol] can be used to generate source reconstructions and target reconstructions. The anomaly detector can additionally comprise a classifier [symbol] , which can be trained to classify source encodings ε(xₜ) and target encodings ε(\hat{x}ₜ) as normal or anomalous. Further, the anomaly detector can comprise a domain classifier [symbol] , which can be trained to identify whether an encoding corresponds to the source domain or the target domain. The classifier [symbol] and domain classifier [symbol] can both comprise multi-layer perceptron classifiers with sigmoid activation functions.

The first loss value is the classification loss value [symbol] _{cls}. This loss value is used during training to evaluate how accurately the classifier [symbol] classifies source time series data values as normal or anomalous. The anomaly detector system can compute the classification loss value [symbol] _{cls}, using a “loss and reward calculator” component (described below), using the following formula:

$${ℒ}_{cls} = {\sum }_{{x}_{t} ∈ X} - {w}_{t} [ {y}_{t} \cdot log ( 𝒞 ( ℰ ( {x}_{t} ) ) ) + ( 1 - {y}_{t} ) \cdot log ( 1 - 𝒞 ( ℰ ( {x}_{t} ) ) ) ]$$

Where yₜ are the labels corresponding to source time series data values xₜ and wₜ are weights associated with these labels, which can be used to emphasize classifying anomalous data values.

The second loss value is the reconstruction loss value [symbol] _{recon}. This loss value is used during training to evaluate how well the anomaly detector is able to generate source encodings, target encodings, as well as use those encoding to generate source reconstructions [symbol] (ε(xₜ)) and target reconstructions [symbol] (ε(\hat{x}ₜ)). The anomaly detector system can compute the reconstruction loss value [symbol] _{recon} recon using the formula:

$${ℒ}_{recon} = {\sum }_{{x}_{t} ∈ {X}^{+} , {\hat{x}}_{t} ∈ \hat{X}} {‖ {x}_{t} - 𝒟 ( ℰ ( {x}_{t} ) ) ‖}_{2}^{2} + {‖ {\hat{x}}_{t} - 𝒟 ( ℰ ( {\hat{x}}_{t} ) ) ‖}_{2}^{2}$$

The third loss value is the alignment loss value [symbol] _{align}, which generally evaluates the consistency of the encoding process, by comparing the difference between generated source encodings ε(xₜ) and target encodings ε(\hat{x}ₜ). The anomaly detector system can compute the alignment loss value [symbol] _{align} using the formula:

$${{ℒ}_{align} = {\sum }_{{x}_{t} ∈ {X}^{+} , {\hat{x}}_{t} ∈ \hat{X}} ‖ ℰ ( {x}_{t} ) - ℰ ( {\hat{x}}_{t} ) ) ‖}_{2}^{2}$$

The fourth loss value is the domain discrimination loss value [symbol] _{disc}, which generally evaluates the domain discriminator's [symbol] ability to distinguish between source encodings ε(xₜ) target encodings ε(\hat{x}ₜ) using the domain discriminator [symbol] and domain labels \tilde{y}ₜ, which indicate whether a corresponding source encoding ε(xₜ) or target encoding ε(\hat{x}ₜ). The anomaly detector system can compute the domain discrimination loss value [symbol] _{disc} using the formula:

$${ℒ}_{disc} = - {\sum }_{{x}_{t} ∈ X ⋃ \hat{X}} {\tilde{y}}_{t} \cdot log ( ( ℰ ( {x}_{t} ) ) ) + ( 1 - {\tilde{y}}_{t} ) \cdot log ( 1 - ( ℰ ( {x}_{t} ) ) )$$

These loss values can be combined to produce a reward value rₜ, which can comprise a “holistic” evaluation of the performance of the anomaly detector component. Four hyper-parameters α, β, γ, and λ can be used to control the weights of individual loss values. This reward value rₜ can be used to train the context sampler and the anomaly detector component during the training phase. The anomaly detector system can use the loss and reward calculator to compute the reward value rₜ according to the formula:

$${r}_{t} = \frac{1}{α \cdot {ℒ}_{cls} + β \cdot {ℒ}_{recon} + γ \cdot {ℒ}_{align} - λ \cdot {ℒ}_{disc}}$$

It may be useful to describe deep learning-based time series anomaly detection, which has been widely studied in data mining community, in more detail. Due to typically limited label information corresponding to anomalies, existing deep learning approaches often assume that normal data instances are compact in hyperspace [Schölkopf et al., Learning with kernels: support vector machines, regularization, optimization, and beyond, MIT press, 2002; Steinwart et al. Journal of Machine Learning Research, 6(2), 2005], and therefore model majority patterns can be effectively identified using autoencoder [Baldi, In Proceedings of ICML workshop on unsupervised and transfer learning, pages 37-49. JMLR Workshop and Conference Proceedings, 2021]neural architecture to identify the decision boundary between anomalies and normalities. Specifically, a fix-sized sliding window can be adopted to segment time series data into subsequences that reflects local patterns of the data. Then, autoencoders [Sakurada and Yairi, In Proceedings of the MLSDA 2014 2nd Workshop on Machine Learning for Sensory Data Analysis, pages 4-11, 2014] can be introduced to model the majority by minimizing the dissimilarity between the input subsequences and the decoded subsequences based on the low-dimensional latent vector generated by the encoder with following loss function:

$${min}_{𝒟 , ℰ} {‖ X - ( ℰ ( X ) ) ‖}_{2}^{2}$$

where X∈ [symbol] ^{t×w×n} is a tensor representing a segmented n-dimensional time series data with window size w and timesteps t, ε and [symbol] are the encoder and decoder. This way, the loss value of the potential anomalous subsequence in timestamp t may be explicitly larger than rest of the subsequences. Additionally, instead of using multi-layer perceptron, LSTM [Kieu et al., In IJCAI, pages 2725-2732, 2019] can be adopted to further capture the temporal correlations between individual subsequences. In embodiments, an LSTM autoencoder can be used as a component of the anomaly detector.

It may also be useful to describe domain adaptation for time series data in more detail, prior to describing embodiments of the present disclosure. Currently, domain adaptation is widely used for analyzing image data due to the consistent image definitions. Two common strategies to perform domain adaptation are domain discrepancy minimization [Long et al., In International conference on machine learning, pages 97-105. PMLR, 2015] and domain discrimination [Tzeng et al., In Proceedings of the IEEE conference on computer vision and pattern recognition, pages 7167-7176, 2017; Long et al., In International conference on machine learning, pages 97-105. PMLR, 2015]. Domain discrepancy minimization introduces a mapping function [symbol] to map source and target domain data into a shared subspace, and then perform distance minimization based on the feature vector of both domains in the subspace:

$${{min}_{ℳ} ‖ ( X ) - ( \hat{X} ) ) ‖}_{2}^{2}$$

Where X and \hat{X} are the source and target domain data, respectively. Recent studies [Cai et al., arXiv preprint arXiv: 2012.11797, 2020] on domain adaptation for time series fault detection use an LSTM-based classification framework that generates source and target domain feature vector using a shared LSTM unit and adopt domain discrepancy minimization with self-attention mechanism to adaptively align the size of subsequences between two domains toward domain adaptation.

Domain discrimination involves conducting adversarial learning using a generator and discriminator. The goal of the generator [symbol] is to generate domain invariant features that cannot be distinguished by the discriminator [symbol] while the target of discriminator is to identify the domain of the input feature vector from the generator:

$${min}_{ℋ} {max}_{𝒢} {𝔼}_{x \sim X ⋃ \hat{X}} [ ( x ) ] + {𝔼}_{z \sim Z} [ log ( 1 - ( ( z ) ) ) ]$$

where z∈Z is a prior noise. By performing the min-max optimization between [symbol] and [symbol] , the generator will be able to generate domain invariant features. Recent studies [Jin et al., arXiv preprint arXiv: 2102.06828, 2021] on domain adaptation for time series forecasting introduces a dual encoder-decoder framework with a shared attention layer as the feature generator to generate domain invariant features to train a domain discriminator.

Having described some of the concepts above, it may be useful to more formally define the problem of domain adaptation for anomaly detection, addressed by embodiments of the present disclosure. Let X=(x₀, x₁ . . . , xₜ) and \hat{X}=(\hat{x}₀, \hat{x}₁ . . . , \hat{x}ₜ) be two fully observed multivariate time series data sets corresponding to a source and target domain respectively and Y∈ [symbol] ^{t+1} comprise labels corresponding to source data set X, which indicates whether an individual source data value xₜ is an anomaly or not. Time series anomaly detection aims to identify if a target time series data value \hat{x}ₜ is anomalous or not. Formally, anomalies can be identified by a scoring function [symbol] : x→ [symbol] that evaluates the extent to which an input data point x is anomalous: the higher the anomaly score, the more anomalous the data point is. Following the context window mechanism to sample time series data, embodiments can train an anomaly detector [symbol] with subsequences of the source data set X and the target data set \hat{X} and source labels Y. In this way, the anomaly detector [symbol] can be adopted to identify anomalous data values in the target data set \hat{X}.

Based on the notations defined above, the problem of context sampling can be defined follows. Given two multivariate time series data, a goal of context sampling is to jointly learn a sampling policy \tilde{π} with a LSTM-based anomaly detector, where \tilde{π} maps each time point from two domains into the context window sizes for xₜ and \hat{x}ₜ (which can be referred to as source window sizes and target window sizes, in order to achieved optimized anomaly detection performance when detecting anomalies in the target data set \hat{X}.

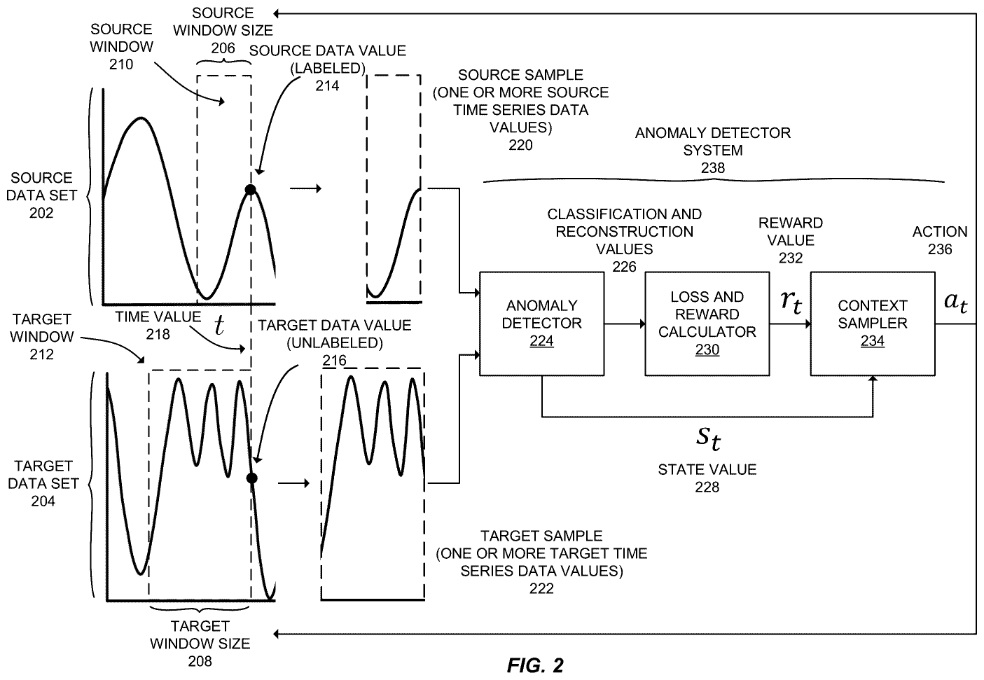

Methods according to embodiments, particularly relating to a training phase and an anomaly detection phase are summarized below with reference to FIG. 2, Both the training process and anomaly detection process are described more accurately and in more detail further below with reference to the other figures. The description of FIG. 2 is primarily for the purpose of orienting the reader, in order to facilitate a better understanding of embodiments of the present disclosure.

Both the training phase and the anomaly detection phase generally comprise iterative processes which can result in training an anomaly detector system 238 (during the training phase) or classifying target time series data values from a target data set 204 (during the anomaly detection phase). A single iteration of this process for the training phase is described below.

The anomaly detector system 238 can use a time value t 218, a source window size 206, and a target window size 212 to sample data from a source data set X 202 and a target data set \hat{X} 204. The source window size 206 and time value t 218 can define a “source window” 210 of time series data from the source data set X 202. Likewise, the target window size \hat{X} 208 and time value t 218 can define a “target window” 212 of time series data from the target data set 204. The source window size 206 and target window size 208 can be unequal. As such, the source window 210 and target window 212 can comprise different amounts of time series data. The anomaly detector system 238 can sample the data in the source window 210 to produce one or more source time series data values xₜ, sometimes referred to as a source sample 220. Likewise, the anomaly detector system 240 can sample the data in the target window 212 to produce one or more target time series data values \hat{x}ₜ, sometimes referred to as a target sample 222. The source sample 220 may comprise labeled source time series data values, such as source data value 214. Likewise, the target sample 222 may comprise unlabeled target time series data values, such as target data value 216.

The one or more source time series data values xₜ 220 and one or more target time series data values \hat{x}ₜ 222 can be input into the anomaly detector component 224, one of three components that can be in the anomaly detector system 238. As described briefly above, the anomaly detector component 224 can use an encoder ε (which may be part of an LSTM autoencoder) to generate a source encoding ε(xₜ) and a target encoding ε(\hat{x}ₜ) using the one or more source time series data values xₜ 220 and the one or more target time series data values \hat{x}ₜ 222 respectively. The source encoding ε(xₜ) and target encoding ε(\hat{x}ₜ) may be of equal size, or otherwise comprise the same amount of data. The anomaly detector 224 can combine the source encoding ε(xₜ) and the target encoding ε(\hat{x}ₜ) to generate a state value sₜ 228, which can be provided to a context sampler 234 (another component of the anomaly detector system 238) for later use. Additionally, the anomaly detector 224 can use some machine learning sub-components, including a classifier [symbol] , a domain classifier [symbol] , and a decoder [symbol] , (which may also be part of the LSTM autoencoder) in order to generate an anomaly classification (or just “classification”), a domain classification, a source reconstruction [symbol] (ε(xₜ)), and a target reconstruction [symbol] (ε(\hat{x}ₜ)), which may collectively be referred to as “classification and reconstruction values” 226. These classification and reconstruction values 226 can be provided to a loss and reward calculator (another component of the anomaly detector system 238).

The loss and reward calculator 230 can use the classification and reconstruction values 226 in order to calculate the loss values described above. These loss values generally measure or otherwise indicate the general performance of the anomaly detector 224, including the performance of the machine learning sub-components described above. As described above, the loss values can be combined into a single reward value rₜ 232, which can also generally indicate the performance of the anomaly detector system 238. The reward value rₜ 232 may increase as the anomaly detector system's 238 performance increases, and decrease as the anomaly detector system's 238 performance decreases. The loss and reward calculator 230 can provide the reward value rₜ 232 to the context sampler 234.

The context sampler 234, modeling the process of window size selection as a Markov decision process (MDP) can use the received state value sₜ 228 to generate an action aₜ 236, comprising a new source window size 206 and a new target window size 208. A training tuple Tₜ, comprising the reward value rₜ 232, the state value sₜ 228, and the action aₜ 236 can be stored in a memory buffer (sometimes represented by [symbol] , not to be confused with the decoder [symbol] ) of the context sampler 234. This training tuple Tₜ, along with any number of previously stored training tuples, can be used to train the context sampler 234, improving the context sampler's 234 ability to generate appropriately sized source and target window sizes. Further, the training tuples be used to train the machine learning sub-components of the anomaly detector 224. These data can be used to train the encoder ε to generate more representative encodings, the decoder [symbol] to generate more accurate reconstructions based on encodings, the classifier [symbol] to better classify encodings as corresponding to normal or anomalous data values, and the domain classifier [symbol] to better determine whether an encoding comprises a source encoding or a target encoding.

The new source window size 206 and the new target window size 208 can be used to generate a new source sample 220 and a new target sample 222, which can then be input into the anomaly detector component 224, repeating the loop. This process can be repeated until the time value t 218 exceeds a training epoch value T, which defines the end of the training process.

The anomaly detection phase, performed after the anomaly detector system 238 can involve a similar iterative process. The anomaly detector system can use a source window size 206 and a target window size 208, as well as time value t 218 to sample one or more source time series data values xₜ 220 and one or more target time series data values \hat{x}ₜ 222. These source time series data values xₜ 220 and target time series data values \hat{x}ₜ 222 can be input into the trained anomaly detector 224. The trained anomaly detector 224 can generate a source encoding ε(xₜ) and a target encoding ε(\hat{x}ₜ) corresponding to the one or more source time series data values xₜ 220 and the one or more target time series data values \hat{x}ₜ using the encoder ε of the trained LSTM autoencoder, a component of anomaly detector 224. Using the source encoding ε(xₜ) and the target encoding ε(\hat{x}ₜ), the anomaly detector 224 can generate a state value sₜ 228, which, like in the training phase, can be provided to the context sampler 234.

The anomaly detector 224 can additionally generate a target classification [symbol] (ε(\hat{x}ₜ)) and a target reconstruction [symbol] (ε(\hat{x}ₜ)) using the target encoding ε(\hat{x}ₜ). The anomaly detector 224 can provide the target reconstruction [symbol] (ε(\hat{x}ₜ)) to the loss and reward calculator 230, which can generate a target reconstruction loss value and provide it back to the anomaly detector 224. Using the target classification [symbol] (ε(\hat{x}ₜ)) and the target reconstruction loss value, the anomaly detector 224 can generate an anomaly score A(\hat{x}ₜ) corresponding to the unlabeled target data value 216. This anomaly score A(\hat{x}ₜ) can be compared to an anomaly threshold (also referred to as a contamination threshold) in order to determine a classification or label for the unlabeled target data value 216, e.g., if the anomaly score is greater than the anomaly threshold, the target data value 216 can be labeled anomalous, otherwise it can be labeled normal.

The context sampler can use a policy function \tilde{π}, trained during the training phase to determine an action aₜ comprising a new source window size 206 and a new target window size 208. The new source window size 206 and new target window size 208 can be used to sample a new set of one or more source time series data values xₜ 220 and a new set of one or more target time series data values \hat{x}ₜ 222, which can then be used to classify a new target data value 216 corresponding to a new time value t 218. The process described above can be repeated iteratively until some or all of the target data values 216 in the target data set \hat{X} 204 have been classified.

It may be helpful to describe some details of the sampling process, in order to facilitate a better understanding of embodiments of the present disclosure. As described above, a window of data (e.g., source window 210 or target window 212) can be defined by a window size and a time value. In some embodiments, a window of data may be constructed by sampling “backwards” from a data point corresponding to the time value t. For example, for a time value t=6 and a window size n=4, a window of data may comprise the data points x₃, x₄, x₅, x₆. Generally, a window of data given a time value t and a window size n can be expressed as xₜ₋ₙ₊₁, xₜ₋ₙ₊₁, . . . , xₜ.

There are a few other cases that are discussed below for the sake of completeness. The first involves the case where the window size n exceeds the time value t. In this case, using the sampling procedure described above, it is not possible to sample a window of data comprising n elements. To overcome this, “wrap around” sampling can be used. For instance, assume an exemplary source data set X=(x₀, x₁, x₂, x₃, x₄) comprising five source time series data values. Assume a time value t=1 and a window size n=3. The source data set can be sampled backwards from x₁, include x₀, then “wrap around” to the back of the data set X to include x₄, producing a data window comprising x₄, x₀, x₁. Using this technique, windows of data of any window size can be generated, regardless of the number of elements in the data set or the time value.

FIG. 2 depicts the anomaly detector system 238 as comprising three elements, an anomaly detector 224, a loss and reward calculator 230, and a context sampler 234. While the anomaly detector system 238 could conceivably comprise three separate physical devices, in some embodiments, the anomaly detector system 238 can comprise a single computer system, referred to below as an “anomaly detector computer system” or just a “computer system.” In such a computer system, the anomaly detector 224, the loss and reward calculator 230, and the context sampler 234 may comprise software modules, comprising code, executable by the computer system for performing their associated functions. However, the functions associated with the anomaly detector 224, the loss and reward calculator 230, and the context sampler 234 may be implemented in other ways, e.g., via a monolithic software application executed by the computer system. The division of the anomaly detector 224, the loss and reward calculator 230, and the context sampler 234 is primarily for the purpose of facilitating the description of methods according to embodiments, and is not intended to be limiting.

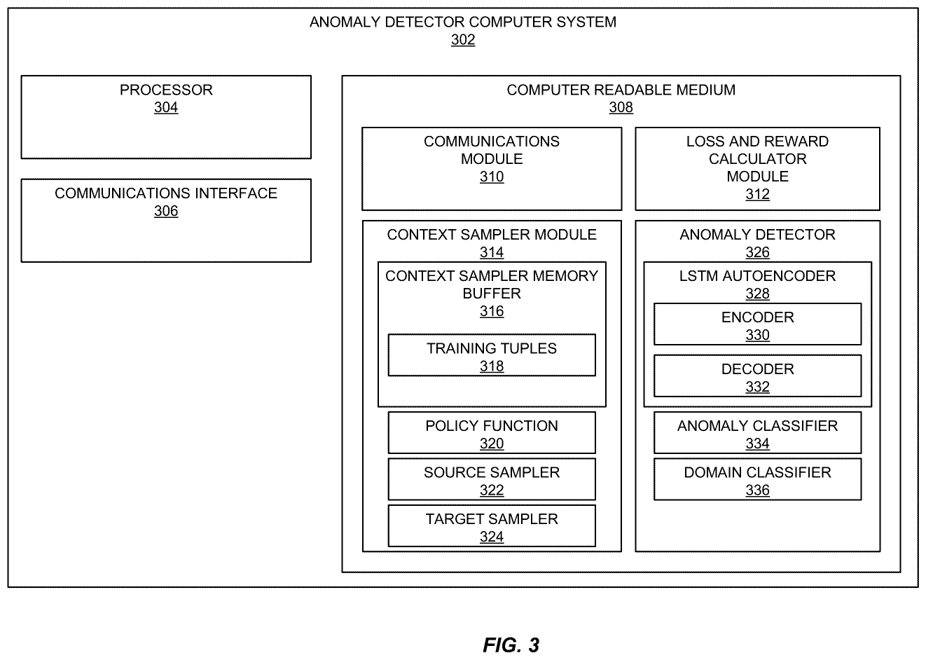

An anomaly detector computer system 302 that can be used to implement some methods according to embodiments is described below with reference to FIG. 3. The anomaly detector computer system 302 can comprise a processor 304, a communications interface 306, and a computer readable medium 308. The computer readable medium 308 can store data, code, and other instructions, including a communications module 310, a loss and reward calculator module 312, a context sampler module 314, and an anomaly detector 326.

Processor 304 may comprise any suitable processing apparatus or device as described above. The communications interface 304 may comprise a network interface (e.g., an Ethernet interface, wireless network card, etc.) that enables the anomaly detector computer system 302 to communicate with other computers or systems over a network such as the Internet. Computer readable medium 308 may comprise any hardware capable of storing data that the anomaly detector computer system 302 can read or write using processor 304. As an example, computer readable medium 308 may comprise a hard disk drive (HDD) solid state drive (SSD), RAM, etc., or any combination thereof.

Communication module 310 may comprise code or instructions that cause or enable processor 304 to generate data, reformat data, transmit data, receive data, and/or otherwise communicate with other entities or computers. Additionally, communication module 310 may enable anomaly detector computer system 302 to communicate over a network using any appropriate communication protocol, such as TCP, UDP, etc.

The loss and reward calculator module 312 may be used to generate loss values [symbol] and reward values rₜ which can be used as part of a training process used to train the context sampler 314 and the anomaly detector 326. As described above, the loss values [symbol] can generally relate to the performance of specific aspects of the anomaly detector 326, and there combination, a reward value rₜ, can comprise a “holistic” metric of the anomaly detector's 326 performance.

The context sampler module 314 can be used to generate actions aₜ comprising source window sizes and target window sizes, which can be used to sample a source data set X and a target data set \hat{X}, as described above. The context sampler module 314 can use source sampler 322 to sample the source data set X, and can use target sampler 324 to sample the target data set \hat{X}. The actions aₜ can be generated using a policy function \tilde{π} 320, which can be trained as part of the training phase. The context sampler 314 can also comprise a context sampler memory buffer 316, which can store training tuples 318. These training tuples can comprise data values used to train the policy function \tilde{π} 320 during the training phase.

The anomaly detector module 326 can perform functions associated with generating encodings and anomaly scores used to evaluate whether target data points are normal or anomalous. The anomaly detector 326 can comprise an LSTM autoencoder 328, which can further comprise an encoder ε 330 and decoder [symbol] 332. The anomaly detector 326 can use the encoder 330 to generate encodings used by the loss and reward calculator module 312 to generate the loss values [symbol] , as well as to generate state values sₜ used by the context sampler to generate actions aₜ. The anomaly detector 326 can additionally comprise an anomaly classifier [symbol] 334 used to classify encodings as normal or anomalous, as well as a domain classifier [symbol] 336 used to discriminate between the source domain and the target domain.

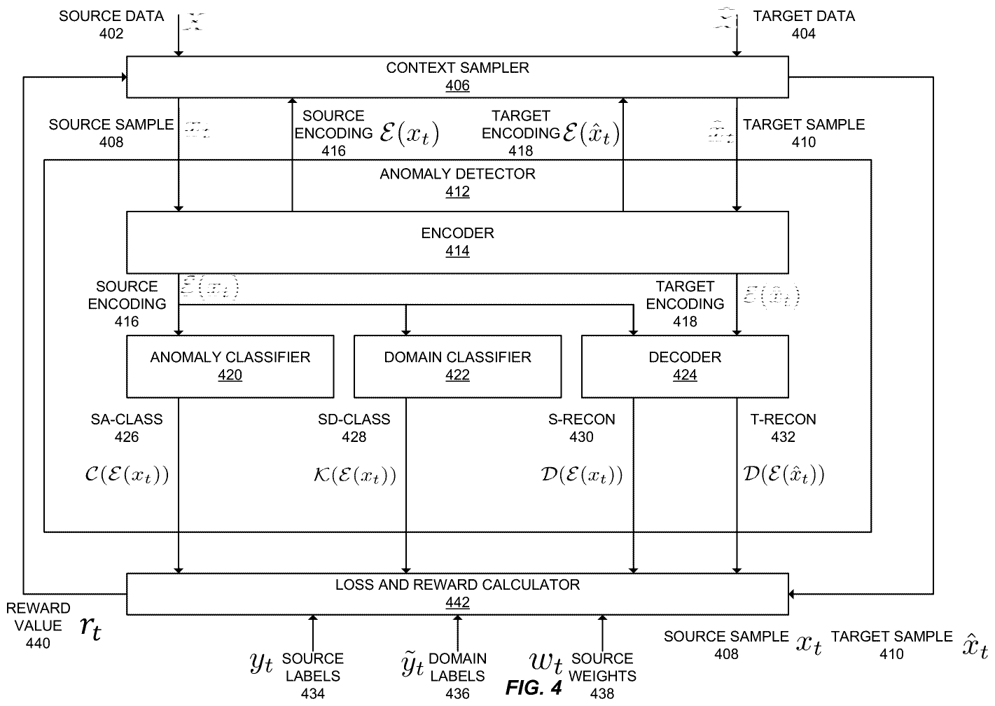

FIG. 4 illustrates the training process from the perspective of the anomaly detector 412. The anomaly detector 412 can receive one or more source time series data values xₜ (sometimes referred to as a source sample) 408 and one or more target time series data values \hat{x}ₜ (sometimes referred to as a target sample) 410 from the context sampler 406. The context sampler 406 can generate these samples by sampling from the source data set X 402 and target data set \hat{X} 404.

Using an encoder 414, the anomaly detector 412 can generate a source encoding ε(xₜ) 416 and a target encoding ε(\hat{x}ₜ) 418 by encoding the source sample xₜ 408 and target sample ε(\hat{x}ₜ) 410 respectively. The source encoding ε(xₜ) 416 and target encoding ε(\hat{x}ₜ) 418 can be used to generate a state value sₜ, which can be returned to the context sampler 406. The state value sₜ can be used by the context sampler 406 to generate an action aₜ, comprising a source window size and a target window size. This action aₜ can be used to sample from the source data set X 402 and target data set \hat{X} 404 in future training rounds.

The anomaly detector 412 can use the source encoding ε(xₜ) 416 and an anomaly classifier [symbol] to generate a source anomaly classification 426 [symbol] (ε(xₜ)). The source encoding ε(xₜ) 416 and a domain classifier [symbol] can also be used to generate a source domain classification [symbol] (ε(xₜ)) 428. Further, the source encoding ε(xₜ) 416 and the target encoding ε(\hat{x}ₜ) 418 can be provided to a decoder [symbol] 424 in order to generate a source reconstruction [symbol] (ε(xₜ)) 430 and a target reconstruction [symbol] (ε(\hat{x}ₜ)) 432.

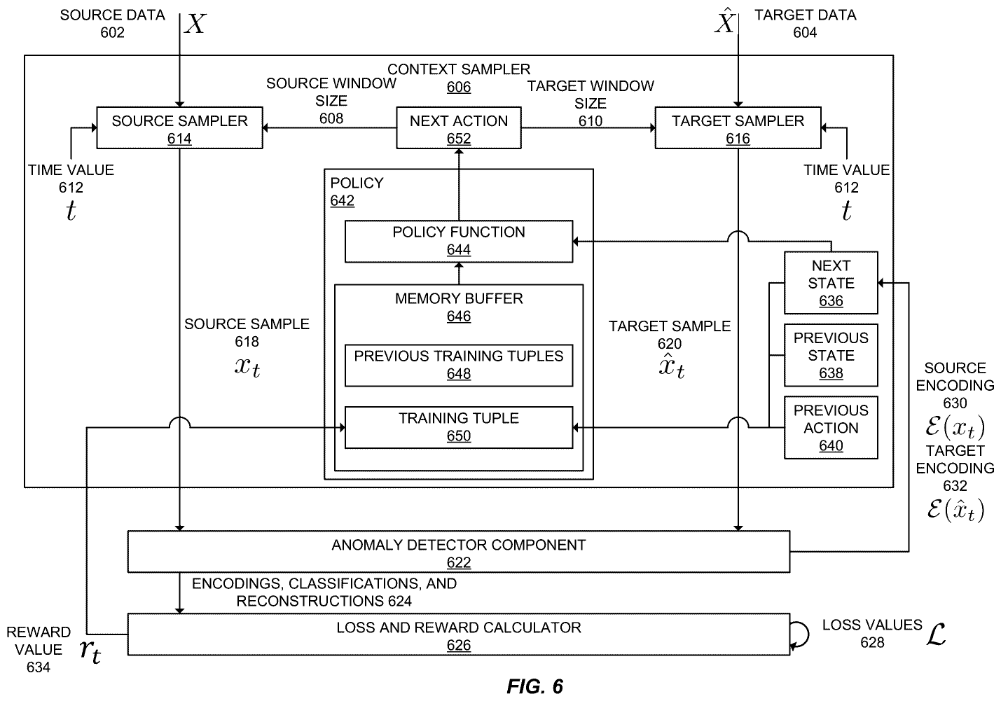

The source anomaly classification [symbol] (ε(xₜ)) 426, the source domain classification [symbol] (ε(xₜ)) 428, the source reconstruction [symbol] (ε(xₜ)) 430, and the target reconstruction [symbol] (ε(\hat{x}ₜ)) 432 can be provided to a loss and reward calculator 442. The loss and reward calculator 442 can additionally receive the source sample xₜ 408 and the target sample \hat{x}ₜ 410 from the context sampler 418. Using these data, along with a set of source labels yₜ 434, domain labels \tilde{y}ₜ 436, and source weights wₜ 438, the loss and reward calculator 442 can calculate one or more loss values [symbol] , which the loss and reward calculator 442 can use to generate a reward value rₜ 440, which can be returned to the context sampler 406. As described below with reference to FIG. 6, the reward value rₜ 440 can be used to train the context sampler 406, i.e., to improve the context sampler's ability 406 to generate source window sizes and target window sizes used to sample the source data set X 402 and target data set \hat{X} 404.

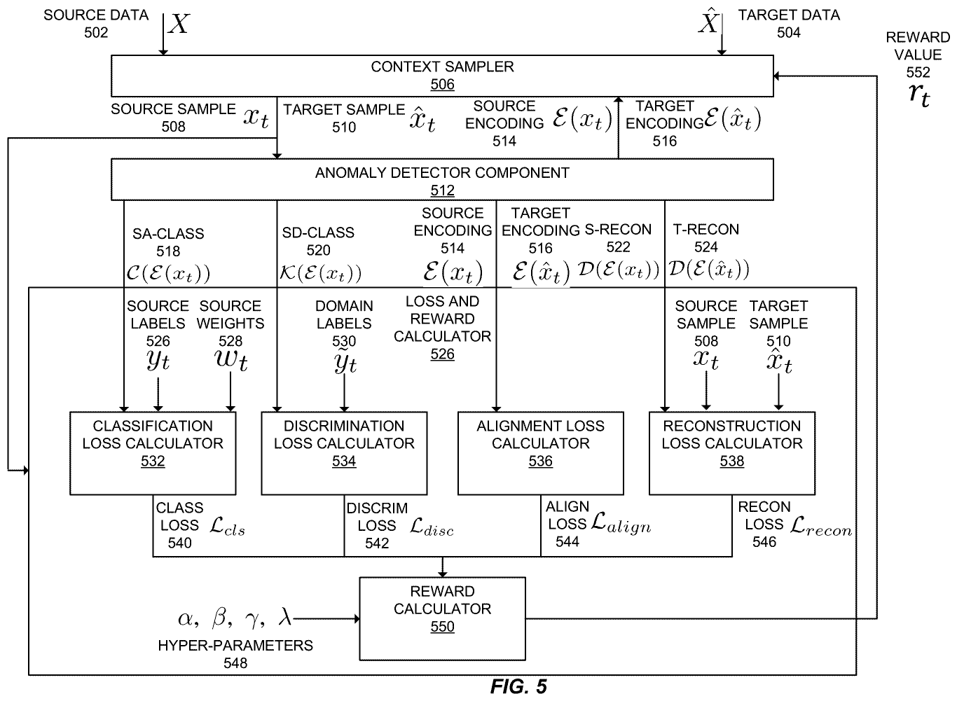

FIG. 5 summarizes the training process from the perspective of the loss and reward calculator 526. As described above with reference to FIG. 4, the loss and reward calculator 526 can receive a variety of data used to calculate loss values [symbol] 540-546 and the reward value rₜ 552. These data may include a source anomaly classification [symbol] (ε(xₜ)) 518, a source domain classification [symbol] (ε(xₜ)) 520, a source encoding ε(xₜ) 514, a target encoding ε(\hat{x}ₜ) 516, a source reconstruction [symbol] (ε(xₜ)) 522, and a target reconstruction [symbol] (ε(xₜ)) 524.

Using these data, the loss and reward calculator 526 can calculate four loss values, a classification loss value [symbol] _{cls} 540, a domain discrimination loss value [symbol] _{disc} 542, an alignment loss value [symbol] _{align} 544, and a reconstruction loss value [symbol] _{recon} 546. The loss and reward calculator 526 can calculate these loss values using a classification loss calculator 532, a discrimination loss calculator 534, an alignment loss calculator 536, and a reconstruction loss calculator 538. These may comprise sub-components of the loss and reward calculator 526 or functions implemented by the loss and reward calculator 526.

The classification loss calculator 532 can calculate the classification loss value [symbol] _{cls} 540 using the source anomaly classification [symbol] (ε(xₜ)) 518, a set of source labels yₜ 526, a set of source weights wₜ 528. The classification loss calculator 532 can calculate the classification loss value [symbol] _{cls} 540 using the formula:

$${ℒ}_{cls} = {\sum }_{{x}_{t} ∈ X} - {w}_{t} [ {y}_{t} \cdot log ( ( ℰ ( {x}_{t} ) ) ) + ( 1 - {y}_{t} ) \cdot log ( 1 - ( ℰ ( {x}_{t} ) ) ) ] .$$

The discrimination loss calculator 534 can calculate the domain discrimination loss value [symbol] _{disc} 542 using the source domain classification [symbol] (ε(xₜ)) 520 and a set of domain labels \tilde{y}ₜ 530. The discrimination loss calculator 534 can calculate the domain discrimination loss value [symbol] _{disc} 542 using the formula:

$${ℒ}_{disc} = - {\sum }_{{x}_{t} ∈ X ⋃ \hat{X}} {\tilde{y}}_{t} \cdot log ( ( ℰ ( {x}_{t} ) ) ) + ( 1 - {\tilde{y}}_{t} ) \cdot log ( 1 - ( ℰ ( {x}_{t} ) ) )$$

The alignment loss calculator 536 can calculate the alignment loss value [symbol] _{align} 544 using the source encoding ε(xₜ) 514 and the target encoding ε(\hat{x}ₜ) 516. The alignment loss calculator 536 can calculate the alignment loss value Lalign 544 using the formula:

$${{ℒ}_{align} = {\sum }_{{x}_{t} ∈ {X}^{+} , {\hat{x}}_{t} ∈ \hat{X}} ‖ ℰ ( {x}_{t} ) - ℰ ( {\hat{x}}_{t} ) ) ‖}_{2}^{2}$$

The reconstruction loss calculator 538 can calculate the reconstruction loss [symbol] _{recon} 546 using the source reconstruction [symbol] (ε(xₜ)) 522, the target reconstruction [symbol] (ε(\hat{x}ₜ)) 524, the source sample xₜ 508, and the target sample \hat{x}ₜ 510. The reconstruction loss calculator 538 can calculate the reconstruction loss value 546 using the formula:

$${ℒ}_{recon} = {\sum }_{{x}_{t} ∈ {X}^{+} , {\hat{x}}_{t} ∈ \hat{X}} {‖ {x}_{t} - ( ℰ ( {x}_{t} ) ) ‖}_{2}^{2} + {‖ {\hat{x}}_{t} - ( ℰ ( {\hat{x}}_{t} ) ) ‖}_{2}^{2}$$

After calculating the loss values 540-546, the loss and reward calculator 526 can use a reward calculator 550, the loss values 540-546, and a set of hyper-parameters α, β, γ, λ to calculate the reward value rₜ 552. The reward calculator 550 can calculate the reward value rₜ 552 using the formula:

$${r}_{t} = \frac{1}{α \cdot {ℒ}_{cls} + β \cdot {ℒ}_{recon} + γ \cdot {ℒ}_{align} - λ \cdot {ℒ}_{disc}}$$

The reward value rₜ 552 can be returned to the context sampler 506, which can use the reward value rₜ 552 as part of a training process used to train the context sampler 506, as described below with reference to FIG. 6.

FIG. 6 shows the training process described above from the perspective of the context sampler 606. The context sampler 606 can sample data from a source data set X 602 and a target data set \hat{X} 604 using a source sampler 614 and a target sampler 616 respectively. The source sampler 614 takes a source window size 608 and a time value t 612 and uses those values to sample a source sample xₜ 618 from the source data set X 602. Likewise, the target sampler 616 can take a target window size 610 and a time value t 612 and uses those data values to sample a target sample \hat{x}ₜ 620 from the target data set \hat{X} 604.

The context sampler can provide the source sample xₜ 618 and target sample \hat{x}ₜ 620 to an anomaly detector component 622, which can use the source sample xₜ 618 and target sample \hat{x}ₜ 620 to generate the encodings, classifications, and reconstructions 624 described above with reference to FIGS. 4 and 5. The anomaly detector component 622 can provide these encodings, classifications, and reconstructions 624 to the loss and reward calculator 626, which can generate loss values 628 as described above. These loss values 628 can be used to calculate a reward value rₜ 634, as described above with reference to FIG. 5, which can be returned to the context sampler 606. Additionally, the anomaly detector component 622 can return the source encoding ε(xₜ) 630 and target encoding ε(\hat{x}ₜ) 632 to the context sampler 606.

The context sampler 606 can use the reward value rₜ 634, source encoding 630, and target encoding 632 in order to train a policy \tilde{π} 642 comprising a policy function 644 and a memory buffer 646. Generally, the policy function 644 takes in a state value sₜ (i.e., next state value 636) as an input and returns an action aₜ (i.e., action 652), which is used to define the source window size 608 and target window size 610, which are used by the source sampler 614 and target sampler 616 to sample subsequent source samples and subsequent target samples from the source data set X602 and target data set \hat{X} 604 respectively.

Training the policy \tilde{π} 642 enables the context sampler 606 to generate source window sizes 608 and target window sizes 610 that lead to better performance by the anomaly detector 622. The policy function 644 is trained using data stored in the memory buffer 646, which may comprise a training tuple Tₜ 650 and one or more previous training tuples 648, generated, for example, in a previous round of the training process. The training tuple Tₜ 650 can be constructed using the reward value rₜ 634 and the next state value sₜ₊₁ 636 generated using the source encoding ε(xₜ) 630 and the target encoding ε(\hat{x}ₜ) 632. The training tuple Tₜ 650 can additional comprise a previous state value sₜ 638, and a previous action aₜ 640, comprising the source window size 608 and target window size 610 used to sample the source sample xₜ 618 and target sample \hat{x}ₜ 620 respectively.

Using the policy \tilde{π} 642, the context sampler 606 can generate a subsequent (or next) action aₜ₊₁ 652, which can be used to generate a new source window size 608 and new target window size 610. These new window sizes can be used by the source sampler 614 and 616 to generate new source samples xₜ₊₁ 618 and new target samples \hat{x}ₜ₊₁ corresponding to subsequent time value t+1 612 in future iterations of the training process. The training process can be repeated until the time value t exceeds a training epoch value T, at which point the training process has been completed.

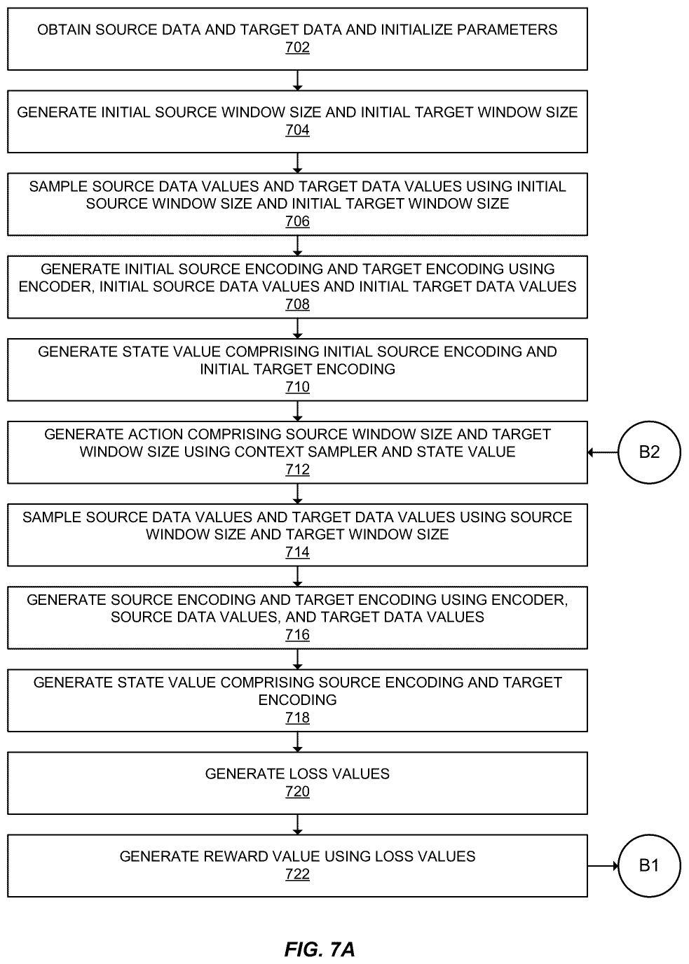

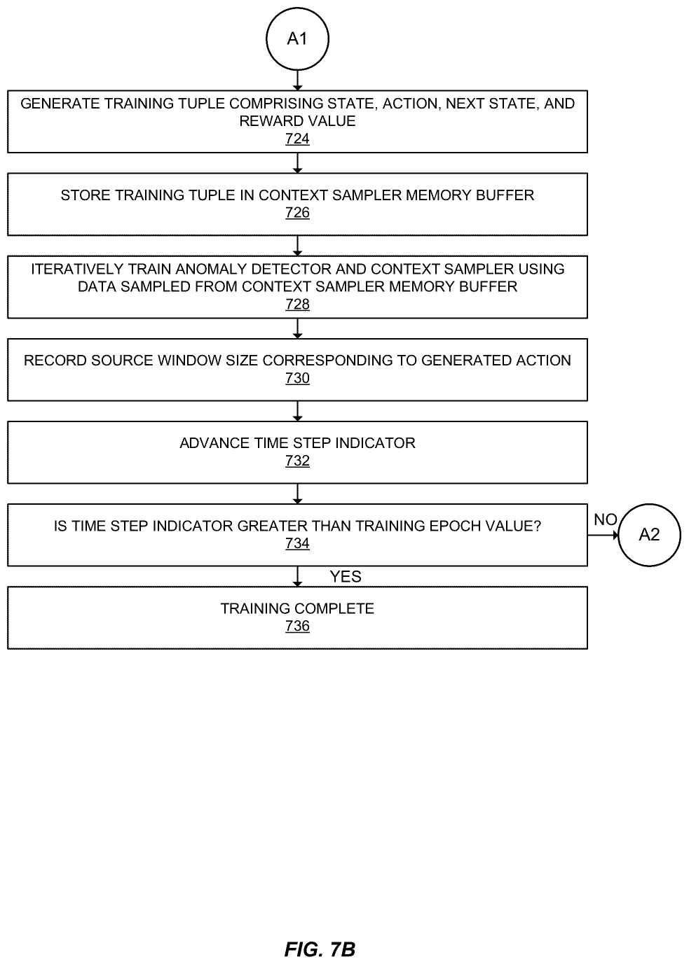

FIG. 7 shows a flowchart of an exemplary method that can be used to train an anomaly detector system during the training phase. As described above, the anomaly detector system may comprise an anomaly detector component, a loss and reward calculator, and a context sampler. Further, the anomaly detector component may comprise multiple sub-models, including an LSTM autoencoder (comprising an encoder ε and decoder [symbol] ), a classifier [symbol] (sometimes referred to as an “anomaly classifier”, which may comprise a multi-layer perceptron classifier with sigmoid activation function), and a domain classifier [symbol] (which also may comprise a multi-layer perceptron classifier). The context sampler may comprise a deep Q network (DQN), which can be used to implement a policy function π, which can be used to generate source window sizes and target window sizes used to sample source time series data values and target time series data values respectively. In general, the training phase (and the method of FIG. 7) can be summarized as training the anomaly detector component (by training the encoder ε, the decoder [symbol] , classifier [symbol] , and domain classifier [symbol] ) and training the context sampler (by training the DQN). Afterwards, during the anomaly detection phase, the anomaly detector system can use the trained anomaly detector and trained context sampler to classify target time series data values as normal or anomalous.

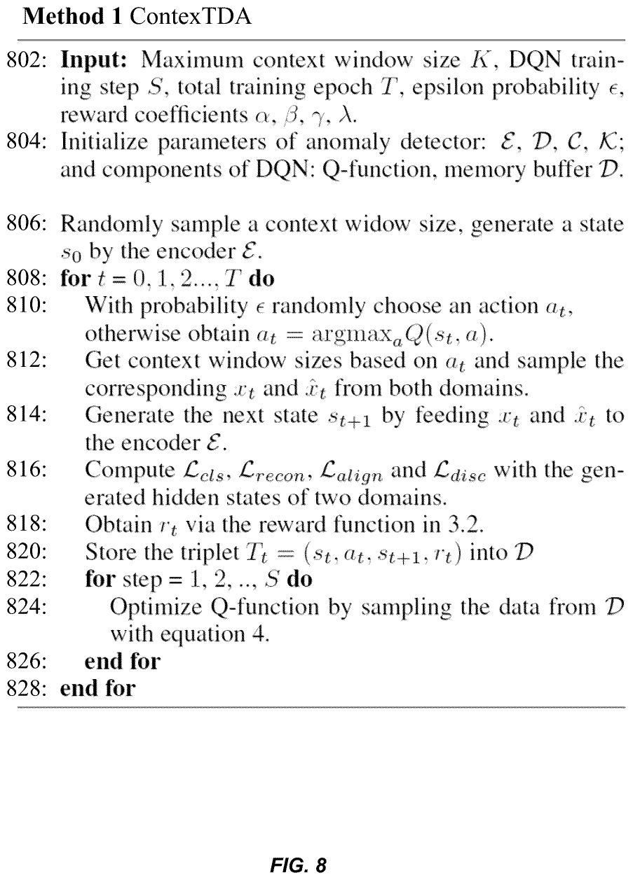

At step 702, a computer system (i.e., the anomaly detector system) can obtain the source data set X and target data set \hat{X} and initialize parameters used to characterize the sub-models used by the anomaly detector and the context sampler. These can include the encoder ε, the decoder [symbol] , classifier [symbol] , and domain classifier [symbol] , as well the DQN (which can comprise a Q-function). Additionally at step 702, the computer system can initialize the memory buffer of the DQN. The anomaly detector system can the source data set X and target data set \hat{X} from, for example, a hard-drive or other form of storage. Alternatively, the anomaly detector system can receive the source data set X and target data set \hat{X} from another computer system, e.g., over a network such as the Internet, or via any other appropriate means. FIG. 8 shows a pseudocode representation of the method of FIG. 7. Step 702 generally corresponds to line 804 in the pseudocode presented in FIG. 8.

At step 704, the computer system can generate an initial source window size and an initial target window size. In some embodiments, the initial source window size and initial target window size can be generated randomly. However, the initial source window size and initial target window size can also be generated using any other appropriate means, e.g., set to some default window size value. The initial source window size and initial target window size can be used to sample initial source time series data values x₀ and initial target time series data values \hat{x}₀, which can be used to setup the iterative training process comprising steps 712-734. Step 704 generally corresponds to part of line 806 in FIG. 8.

At step 706, the computer system can sample one or more initial source time series data values x₀ from a source data set X. Likewise at step 706, the computer system can sample one or more initial target time series data values \hat{x}₀ from the target data set \hat{X}. The computer system can sample the one or more initial source time series data values x₀ and the one or more initial target time series data values \hat{x}₀ using the initial source window size and the initial target window size respectively. Step 706 generally corresponds to part of line 806 in FIG. 8.

The one or more initial source time series data values x₀ can comprise a subsequence of the source data set X, where a number of initial source time series data values x₀ in the subsequence of the source data set X is proportional to the initial source window size. For example, if the initial source window size is 10, the one or more initial source time series data values x₀ can comprise a subsequence of 10 source time series data values from the source data set X.

Likewise, the one or more initial target time series data values \hat{x}₀ can comprise a subsequence of the target data set \hat{X}, where a number of initial target time series data values \hat{x}₀ in the subsequence of the target data set \hat{X} is proportional to the initial target window size. For example, if the initial target window size is “five minutes,” the one or more initial target time series data values \hat{x}₀ can comprise a subsequence of target time series data values covering a five minute time period from the target data set \hat{X}.

In some embodiments, the computer system can sample one or more initial source time series data values x₀ from the source data set X using the initial source window size and based on a time value t=0. As described above, the computer system can sample “backwards” from a source data value defined by the time value t based on the window size. For example if the time value t=10, and the window size n=4, the one or more initial source time series data values xₜ can comprise x₁₀=(x₇,x₈, x₉, x₁₀). The same “backwards” sampling procedure, described above, can be used to sample the one or more initial target time series data values \hat{x}ₜ from the target data set \hat{X}.

Typically, the method according to FIG. 7 involves iterating through the source data set X and target data set \hat{X} based on a time value t until the time value reaches a “training epoch value” T, used to define the length of the training phase. This process can be performed sequentially, starting at the first time value (e.g., t=0) and proceeding through each time value (t=1, t=2, t=3, etc.) until the time value t exceeds the training epoch value T. In such a case, particularly for low values of t, the computer system may use “wrap-around” sampling, as described above, to sample from the source data set X and the target data set \hat{X}. For example, assuming a source data set X comprising 100 source time series data values (x₀, . . . , x₉₉), a time value t=0, and a window size n=6, the one or more initial source time series data values x₀ could comprise (x₉₅, x₉₆, x₉₇, x₉₈, x₉₉, x₀). Wrap around sampling can also be used to sample the one or more initial target data values \hat{x}₀.

At step 708, the computer system can generate an initial source encoding ε(x₀) using the encoder ε and the one or more initial source time series data values x₀. Likewise, the computer system can generate an initial target encoding ε(\hat{x}₀) using the encoder ε and the one or more initial target time series data values \hat{x}₀. In some embodiments, the initial source encoding ε(x₀) and initial target encoding ε(\hat{x}₀) may be the same length, e.g., comprise the same amount of data.

At step 710, the computer system can generate a state value s₀ using the one or more initial source time series data values x₀ and the one or more initial target time series data values \hat{x}₀. More specifically, the computer system generate the state value s₀ using the initial source encoding ε(x₀) and the initial target encoding ε(\hat{x}₀). In some embodiments, the initial state value s₀ can comprise a concatenation of the initial source encoding ε(x₀) and the initial target encoding ε(\hat{x}₀), i.e., s₀=(ε(x₀), ε(\hat{x}₀)). Step 710 generally corresponds to line 806 in FIG. 8.

Steps 712-734 generally correspond to a single iteration of an iterative training process according to some embodiments. This iterative process generally involves iterating through the source data set and target data set based on a time value t. e.g., the first iteration can be performed using time value t=0, the second iteration can be performed using time value t=1, the third iteration can be performed using time value t=3 and so on. Steps 712-734 can be repeated for each time value t up to a training epoch value T, which generally defines the length of the training process. Steps 712-734 generally correspond to the “for loop” defined by lines 808 to 828 in FIG. 8.

At step 712, the computer system can use the context sampler to generate an action aₜ comprising a source window size and a target window size using the state value sₜ generated at step 710. The state value sₜ can be input into a policy implemented using the DQN (and Q-function) implemented by the context sampler to produce the action aₜ comprising the source window size and the target window size. The DQN can implement an ϵ greedy function to generate the action aₜ, such that the DQN produces a random action aₜ with small probability ϵ, and produces an action aₜ in an attempt to maximize a cumulative reward (based on its training) otherwise (e.g., with probability 1−ϵ). Step 712 generally corresponds to line 810 in FIG. 8. As described below, this source and target window size can be used to sample source data values and target data values, e.g., as described above with reference to step 706.

At step 714, the computer system can sample one or more source time series data values xₜ from a source data set X. Likewise at step 714, the computer system can sample one or more target time series data values \hat{x}ₜ from the target data set \hat{X}. The computer system can sample the one or more source time series data values xₜ and the one or more target time series data values \hat{x}ₜ using the source window size and the target window size respectively. Step 714 generally corresponds to part of line 812 in FIG. 8.

The one or more source time series data values xₜ can comprise a subsequence of the source data set X, where a number of source time series data values in the subsequence of the source data set X is proportional to the source window size. For example, if the source window size is 10, the one or more source time series data values xₜ can comprise a subsequence of 10 source time series data values from the source data set X. Likewise, the one or more target time series data values \hat{x}ₜ can comprise a subsequence of the target data set \hat{X}, where a number of target time series data values in the subsequence of the target data set \hat{X} is proportional to the target window size. For example, if the target window size is “five minutes,” the one or more target time series data values \hat{x}ₜ can comprise a subsequence of target time series data values covering a five minute time period from the target data set \hat{X}.

The computer system can use any appropriate sampling method, such as those described above, to sample the one or more source time series data values xₜ and the one or more target time series data values \hat{x}ₜ. This can include a cyclical sampling process, such as “wrap-around” sampling in order to sample the one or more source time series data values xₜ and the one or more target time series data values \hat{x}ₜ (as well as the one or more initial source time series data values x₀ and the one or more target time series data values \hat{x}₀.

At step 716, the computer system can generate a source encoding ε(xₜ) and a target encoding ε(\hat{x}ₜ) using the encoder ε, the one or more source time series data values xₜ and the one or more target time series data values \hat{x}ₜ. The computer system can do this in substantially the same was as it generated the initial source encoding ε(x₀) and initial target encoding ε(\hat{x}₀) in step 708, e.g., by inputting the one or more source time series data values xₜ and the one or more target time series data values \hat{x}ₜ into the encoder ε.

At step 718, the computer system can update the state value sₜ to an updated state value sₜ₊₁ using the one or more source time series data values xₜ and the one or more target time series data values \hat{x}ₜ. More specifically, the computer system can generate the updated state value sₜ₊₁ by combining (e.g., concatenating) the source encoding ε(xₜ) and a target encoding ε(\hat{x}ₜ), similar to step 710. In the first iteration of the loop comprising steps 712-734 (and by extension, lines 808-828 of FIG. 8), the state value sₜ can be updated from the initial state value s₀ to an updated state value s₁. Step 718 generally corresponds to line 814 of FIG. 8.

At step 720, the computer system can compute one or more loss values (e.g., using a loss and reward calculator component). These loss values can be later used to compute a reward value rₜ, which can be used to train the anomaly detector system, including the encoder ε, the decoder [symbol] , the classifier [symbol] , the domain classifier [symbol] , and the DQN. These one or more loss values can comprise a classification loss value [symbol] _{cls}, a reconstruction loss value [symbol] _{recon}, an alignment loss value [symbol] _{align} and a domain discrimination loss value [symbol] _{disc}. Step 720 generally corresponds to line 816 of FIG. 8. The “generated hidden states of two domains” referenced in line 816 refers to the source encoding ε(xₜ) and target encoding ε(\hat{x}ₜ).

The classification loss value [symbol] _{cls} can be calculated using the classifier [symbol] , the encoder ε, the one or more source time series data values xₜ sampled at step 714, one or more labels yₜ corresponding to the one or more source time series data values xₜ, and one or more weights wₜ corresponding to the one or more source time series data values xₜ. More specifically, the computer system can use the anomaly detection component to input the source encoding ε(xₜ) into the classifier [symbol] thereby producing a source classification [symbol] (ε(xₜ)). The source classification [symbol] (ε(xₜ)), the one or more source time series data values xₜ, the one or more labels yₜ, and the one or more weights wₜ using the formula below:

$${ℒ}_{cls} = {\sum }_{{x}_{t} ∈ X} - {w}_{t} [ {y}_{t} \cdot log ( ( ℰ ( {x}_{t} ) ) ) + ( 1 - {y}_{t} ) \cdot log ( 1 - ( ℰ ( {x}_{t} ) ) ) ]$$

As described above, the source data set X can be labeled. These labels yₜ can indicate whether their corresponding source time series data values xₜ are normal or anomalous. The weights wₜ can be used to influence the classification loss value [symbol] _{cls} in order to emphasize detection of anomalous data values (as opposed to, e.g., correctly detecting normal data values).

The reconstruction loss value [symbol] _{recon} can be calculated using the encoder ε, the decoder [symbol] , the one or more source time series data values xₜ and the one or more target time series data values \hat{x}ₜ. More specifically, the computer system can use the anomaly detector component and the source encoding ε(xₜ) to generate a source reconstruction [symbol] (ε(xₜ)) by inputting the source encoding ε(xₜ) into the decoder [symbol] . Likewise, the computer system can use the anomaly detector component and the target encoding ε(\hat{x}ₜ) to generate a target reconstruction [symbol] (ε(\hat{x}ₜ)) by inputting the target encoding ε(\hat{x}ₜ) into the decoder [symbol] . The computer system can then use the loss and reward calculator to compute the reconstruction loss value [symbol] _{recon} using the source reconstruction [symbol] (ε(\hat{x}ₜ)), the target reconstruction [symbol] (ε(\hat{x}ₜ)), the one or more source time series data values xₜ and the one or more target time series data values \hat{x}ₜ according to the formula:

$${ℒ}_{recon} = {\sum }_{{x}_{t} ∈ {X}^{+} , {\hat{x}}_{t} ∈ \hat{X}} {‖ {x}_{t} - ( ℰ ( {x}_{t} ) ) ‖}_{2}^{2} + {‖ {\hat{x}}_{t} - ( ℰ ( {\hat{x}}_{t} ) ) ‖}_{2}^{2}$$

The alignment loss value [symbol] _{align} can be calculated using the encoder ε, the one or more source time series data values xₜ and the one or more target time series data values \hat{x}ₜ. More specifically, the computer system can use the encoder ε to generate the source encoding ε(xₜ) and target encoding ε(\hat{x}ₜ) (as described above in step 716), then use the source encoding ε(xₜ) and target encoding ε(\hat{x}ₜ) to compute the alignment loss value [symbol] _{align} using the formula:

$${{ℒ}_{align} = {\sum }_{{x}_{t} ∈ {X}^{+} , {\hat{x}}_{t} ∈ \hat{X}} ‖ ℰ ( {x}_{t} ) - ℰ ( {\hat{x}}_{t} ) ) ‖}_{2}^{2}$$

The domain discrimination loss value [symbol] _{disc} can be calculated using the encoder ε, the domain classifier [symbol] , the one or more source time series data values xt, the one or more target time series data values \hat{x}ₜ and one or more domain labels \tilde{y}ₜ. The domain labels \tilde{y}ₜ can indicate, for each data value in the one or more source time series data values xₜ and the one or more target time series data values \hat{x}ₜ, whether that data value comprises a source data value or a target data value. More specifically, the computer system can use the encoder ε of the anomaly detector component to generate the source encoding ε(xₜ) and target encoding ε(\hat{x}ₜ) (as described above in step 716), then generate a source domain classification [symbol] (ε(xₜ) and a target domain classification [symbol] (249 (\hat{x}ₜ)) using the domain classifier [symbol] , the source encoding ε(xₜ), and target encoding 249 (\hat{x}ₜ), then calculate the domain discrimination loss value [symbol] _{disc} using the formula:

$${ℒ}_{disc} = - {\sum }_{{x}_{t} ∈ X ⋃ \hat{X}} {\tilde{y}}_{t} \cdot log ( ( ℰ ( {x}_{t} ) ) ) + ( 1 - {\tilde{y}}_{t} ) \cdot log ( 1 - ( ℰ ( {x}_{t} ) ) )$$

At step 722, the computer system can compute a reward value rₜ using the one or more source time series data values xₜ and one or more target time series data values \hat{x}ₜ. More specifically, the computer system can compute the reward value rₜ using the one or more loss values described above, e.g., the classification loss value [symbol] _{cls}, the reconstruction loss value [symbol] _{recon}, the alignment loss value [symbol] _{align}, and the domain discrimination loss value [symbol] _{disc}. The reward value rₜ may also be computed using a classification hyper-parameter α, a reconstruction hyper-parameter β, an alignment hyper-parameter γ and a domain discrimination hyper-parameter λ. Step 722 generally corresponds to line 818 of FIG. 8. As described below, the reward value rₜ can be used to train the anomaly detector system, including the DQN, the encoder ε, the decoder [symbol] , the classifier [symbol] , and the domain classifier [symbol] . The reward value rₜ (also presented as [symbol] (sₜ, aₜ), a function of the state value sₜ and an action aₜ), can be computed using the formula:

$${r}_{t} = ( {s}_{t} , {a}_{t} ) = \frac{1}{α \cdot {ℒ}_{cls} + β \cdot {ℒ}_{recon} + γ \cdot {ℒ}_{align} - λ \cdot {ℒ}_{disc}}$$

Referring now to FIG. 7B, at step 724, the computer system can generate a training tuple Tₜ comprising the “current” state value sₜ, the updated state value sₜ₊₁ generated at step 718, the action aₜ generated at step 712, and the reward value rₜ generated at step 722. In some embodiments, if this is the first iteration of the loop comprising steps 712-734, the current state value sₜ can comprise the initial state value s₀ generated at step 710. Otherwise, the current state value sₜ can comprise whichever state value sₜ was used to generate the action aₜ at step 712, as opposed to the updated state value sₜ₊₁ generated at step 718. This training tuple Tₜ can be used to train the DQN, and the reward value rₜ in the training tuple Tₜ can be used to train the encoder ε, the decoder [symbol] , the classifier [symbol] , and the domain classifier [symbol] , as described further below. Step 724 generally corresponds to line 820 of FIG. 8.

At step 726, the computer system can store the training tuple Tₜ (including the state value sₜ, the action aₜ (comprising the source window size and the target window size), the updated state value sₜ₊₁, and the reward value rₜ) in a memory buffer (sometimes represented by [symbol] , not to be confused with the decoder [symbol] ) of the context sampler. The context sampler memory buffer can store the training tuple Tₜ along with one or more previous training tuples, which may have been generated in previous rounds of training, these training tuples can be used, collectively, to train the anomaly detector system. Step 726 generally corresponds to line 820 of FIG. 8.

At step 728, the computer system can train the context sampler and anomaly detector in an iterative process using sampled data from the memory buffer D of the context sampler. The sampled data used to train the context sampler and anomaly detector can comprise the training tuple Tₜ and one or more previous tuples stored in the memory buffer. Training the anomaly detector can comprise training the encoder ε, the decoder [symbol] , the classifier [symbol] , and the domain classifier [symbol] . The iterative process of step 728 corresponds to lines 822-826 of FIG. 8.

The iterative training process can involve a number of steps defined by a DQN training step S. Training a DQN is a generally understood process within the field of machine learning, and won't be described in great detail herein. In general terms, in embodiments, training a DQN involves optimizing a Q-function Q(sₜ, aₜ) associated with the context sampler based on the reward value rₜ. The broad idea is to determine values corresponding to parameters that characterize the Q-function Q(sₜ, aₜ) (e.g., weights associated with a recurrent neural network) in order to determine a relationship between states sₜ and actions aₜ that maximizes the cumulative expected reward rₜ. Any appropriate optimization process, such as stochastic gradient descent can be used to optimize the Q-function Q(sₜ, aₜ).

Optimizing the Q-function Q(sₜ, aₜ) during the training phase generally enables the context sampler to implement a trained policy \tilde{π}(sₜ) during the anomaly detection phase. The trained policy \tilde{π}(sₜ) can take in the current state sₜ as an input and produce an action aₜ. The trained policy \tilde{π}(sₜ) can use the relationship, determined during the Q-function Q(sₜ, aₜ) optimization, to map states sₜ to actions aₜ. Because the Q-function Q(sₜ, aₜ) is optimized to establish a relationship between states sₜ, actions aₜ, and a high cumulative expected reward rₜ, and because the actions aₜ comprise source window sizes and target window sizes used to sample source data and target data, and because the reward value rₜ corresponds to the performance of the anomaly detector, the trained policy \tilde{π}(sₜ) can effectively produce actions aₜ that result in high performance by the anomaly detector during the anomaly detection phase, enabling the anomaly detector to better classify or labeled target time series data values corresponding to the target data set \hat{X}.

Phrased another way, optimizing the Q-function Q(sₜ, aₜ) can improve the quality of one or more actions aₜ comprising one or more source window sizes and one or more target window sizes generated by the context sampler. This can in turn improve the quality of one or more encodings, one or more reconstructions, one or more classifications, and one or more domain classifications generated by the anomaly detector, thereby reducing one or more loss values computed by the anomaly detector, thereby increasing the reward value rₜ. The optimized Q-function Q(sₜ, aₜ) can be used to implement a policy function \tilde{π}(sₜ) which can be used during an anomaly detection process to generate one or more actions aₜ comprising one or more source window sizes and one or more target window sizes used to label one or more target time series data values as normal or anomalous.

As stated above, The iterative training process of step 728 can also comprise the computer system training the encoder ε, the decoder [symbol] , the classifier [symbol] , and the domain classifier [symbol] . Like the DQN, each of these sub-models may be characterized by a set of parameters. Each sub-model may be trained by determining sets of parameters that are associated with higher reward values rₜ contained in the training tuples Tₜ stored in the context sampler memory buffer. Techniques such as stochastic gradient descent, limited-memory Broyden-Fletcher-Goldfarb-Shanno, etc. can be used to optimize the model parameters based on the reward values rₜ.

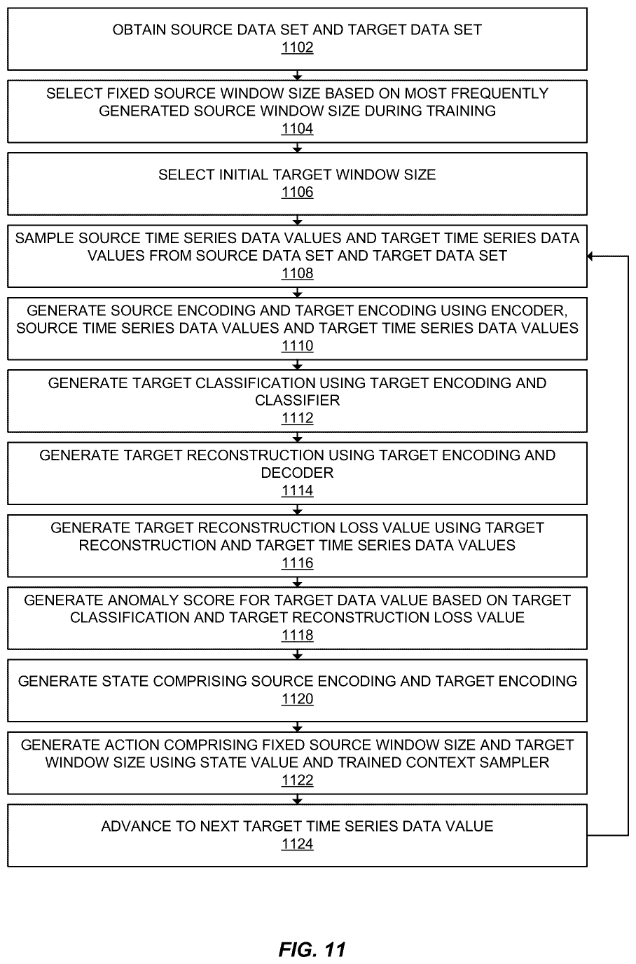

As described below with reference to FIG. 11, in some embodiments, during the anomaly detection phase, the source window size may be fixed, in order to induce the policy function \tilde{π}(sₜ) to be more responsive to the target data set \hat{T}, in order to improve the anomaly detection rate for target time series data values. As such, the computer system may need to determine a fixed source window size. To this end, optionally, at step 730, the computer system can record the source window size corresponding to the action aₜ generated at step 712. As such, over the course of several training rounds, the computer system can record each source window size, thereby recording a plurality of source window sizes proportional to the training epoch value (T). After completing the training process, the computer system can use a plurality of source window sizes recorded over the course of the training process to determine a frequently selected source window size based on the plurality of source window sizes, which can be used as the fixed source window size during the anomaly detection process.

At step 732, the anomaly detector can advance the time value t (sometimes referred to as a time step indicator t) used to sample data from the source data set X and the target data set \hat{X}, as described above in step 706. Afterwards, the anomaly detector can check if the time step indicator t is greater than the training epoch value T. If so, the training process has been completed, and the computer system can advance to step 736. Otherwise, the computer system can return to step 712 and use the updated state value sₜ₊₁ to generate a new action aₜ₊₁. This process can be repeated until the time step indicator exceeds the training epoch value T, at which point the training phase can be completed.

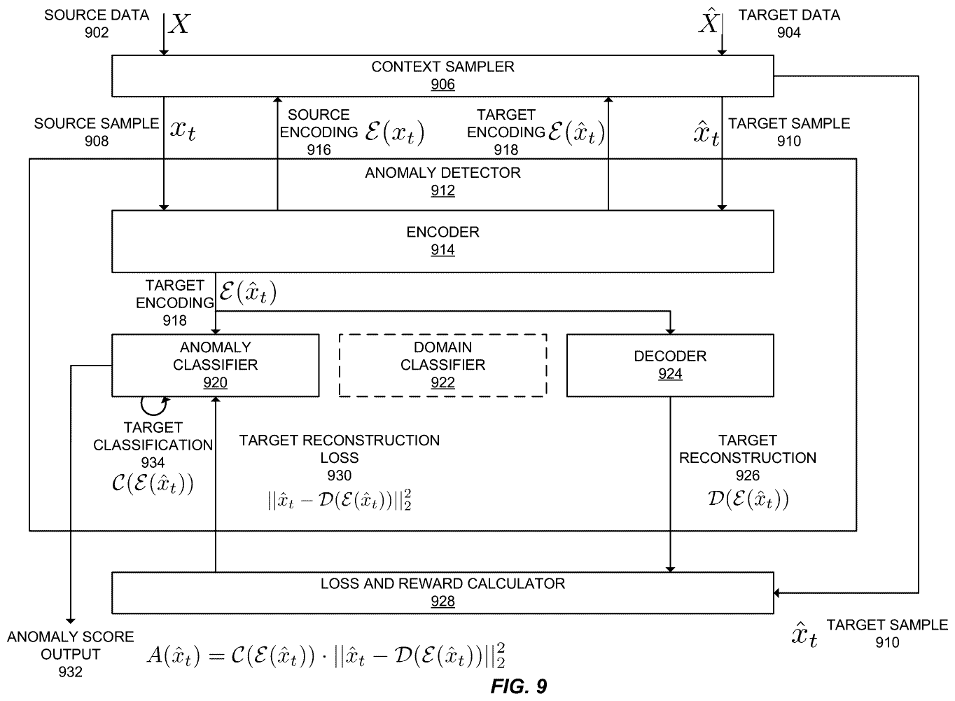

FIG. 9 shows a block diagram used to summarize an iteration of the anomaly detection phase from the perspective of the anomaly detector component 912. The anomaly detector 912 can receive a source sample (i.e., one or more source time series data values) xₜ 908 and a target sample (i.e., one or more target time series data values) \hat{x}ₜ 910 from the context sampler 906. The context sampler 906 can sample the source sample xₜ 908 and the target sample \hat{x}ₜ 910 from the source data set X 902 and target data set \hat{X} 904 respectively, using, e.g., a time value t, a source window size, and a target window size.

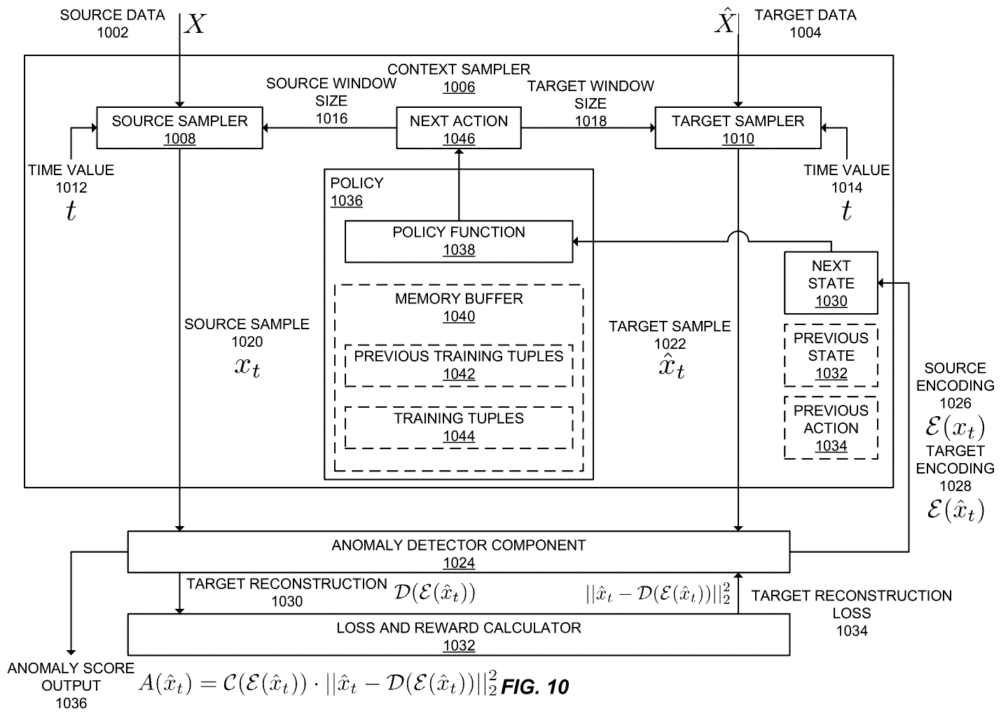

Using an encoder 914, the anomaly detector 912 can generate a source encoding ε(xₜ) 916 and a target encoding ε(\hat{x}ₜ) 918, which can be returned to the context sampler 906 to generate a state value sₜ. This state value sₜ can be used by the context sampler to generate an action aₜ, comprising a source window size and a target window size, which can be used to generate future source samples and target samples, as described below with reference to FIG. 10.

The target encoding ε(\hat{x}ₜ) 918 can be provided to the trained anomaly classifier 920, as well as the decoder [symbol] 924. The decoder [symbol] 924 can generate a target reconstruction [symbol] (ε(\hat{x}ₜ)) 926 by decoding the target encoding ε(\hat{x}ₜ) 918. The target reconstruction [symbol] (ε(\hat{x}ₜ)) 926 can be provided to a loss and reward calculator 928. The loss and reward calculator 928 can use the target reconstruction [symbol] (ε(\hat{x}ₜ)) and the target sample \hat{x}ₜ 910 (received from the context sampler 906) to generate a target reconstruction loss value |\hat{x}ₜ− [symbol] (ε(\hat{x}ₜ))∥₂² 930, which can be returned to the anomaly classifier 920. Using the target encoding 918, the anomaly classifier can generate a target classification [symbol] (ε(\hat{x}ₜ) 934, which can be combined with the target reconstruction loss value |\hat{x}ₜ− [symbol] (ε(\hat{x}ₜ))∥₂² 930 to generate the anomaly score output A(\hat{x}ₜ) 932, using the formula pictured in FIG. 9 and reproduced below:

A(\hat{x}ₜ)= [symbol] (ε(\hat{x}ₜ))·∥\hat{x}ₜ− [symbol] (\hat{x}ₜ))∥₂²

FIG. 10 shows an iteration of the anomaly detection phase from the perspective of the context sampler component 1006. Using a time value t 1012 and a source window size, the context sampler 1006 can use source sampler 1008 to sample a source sample xₜ 1020. Likewise, using a time value 1012 and a target window size 1018, the context sampler 1018 can sample a target sample \hat{x}ₜ 1022 using target sampler 1010. As described above with reference to FIG. 9, the context sampler 1006 can provide the source sample xₜ 1020 and target sample \hat{x}ₜ 1022 to the anomaly detector component 1024. The anomaly detector 1024 can produce an anomaly score output A(\hat{x}ₜ) 1036, as described above with reference to FIG. 9

Additionally, the anomaly detector 1024 can transmit the source encoding ε(xₜ) 1026 and target encoding ε(\hat{x}ₜ) 1028 to the context sampler 1006. The context sampler 1006 can use ε(xₜ) 1026 and target encoding 149 (\hat{x}ₜ) to create the next state sₜ₊₁ 1030, which can be used as the input to the trained policy function \tilde{π} 1038. The trained policy function \tilde{π} 1038 can use the next state sₜ₊₁ 1030 to generate a next action aₜ₊₁ 1046, which can be used to generate source window sizes and target window sizes for sampling new source samples and target samples, enabling the anomaly detector component 1024 to generate anomaly scores A(\hat{x}ₜ₊₁) corresponding to subsequent target data values \hat{x}ₜ₊₁.

FIG. 11 shows a flowchart of an anomaly detection method according to some embodiments, which generally corresponds to an anomaly detection phase as described above. After training the anomaly detector system during the training phase using the training methods described above, the anomaly detector system can be used to classify target time series data values as normal or anomalous. This can be an iterative process, performed sequentially on the target time series data values in a target data set \hat{X}. For example, assuming the target data set \hat{X} comprises 100 target time series data values (\hat{x}₁, \hat{x}₂, . . . , \hat{x}₁₀₀), the trained anomaly detector system could first classify \hat{x}₁ as normal or anomalous, then classify \hat{x}₂, then classify \hat{x}₃ until some or all 100 of the target time series data values have been classified as normal or anomalous. In each case, the anomaly detector system can use a context sampler trained using the methods described above to set source window sizes and target window sizes, in order to sample source time series data and target time series data used to classify the data values (\hat{x}₁, \hat{x}₂, . . . , \hat{x}₁₀₀) as normal or anomlous.

At step 1102, a computer system (i.e., the anomaly detector system) can obtain a source data set X and a target data set \hat{X}. The computer system can obtain these data sets via any applicable means. For example, the computer system can retrieve these data sets from a memory element (e.g., a hard drive) or receive them from another computer system, such as a database server or a client computer, over a network such as the Internet. The source data set X can comprise a plurality of source time series data values xₜ. Likewise, the target data set \hat{X} can comprise a plurality of target time series data values \hat{x}ₜ. The plurality of source time series data values xₜ may be labeled and the plurality of target time series data values \hat{x}ₜ may be unlabeled.

At step 1104, the computer system can set an initial source window size and an initial target window size. The initial source window size can be used to sample source time series data values xₜ from the source data set X and the initial target window size can be used to sample target time series data values \hat{x}ₜ from the target data set \hat{X}. These source time series data values xₜ and target time series data values \hat{x}ₜ can be used to classify a target time series data value (e.g., \hat{x}₁, corresponding to a time value t=1) as normal or anomalous.

In some embodiments, source window sizes (including the initial source window size) used to sample source time series data values xₜ may be fixed or constant, such that the initial source window size is equal to any subsequent source window sizes generated during the anomaly detection phase. Fixing the source window size may make the trained context sampler more “sensitive” to the effect of target window size on anomaly classification, and may improve anomaly classification rates. In embodiments that use fixed source window sizes, the computer system can use a most frequently selected source window size during training as the fixed source window size (and, by extension, the initial source window size). This most frequently selected source window size can be determined using the source window sizes recorded during step 730 of FIG. 7. The computer system can perform statistical analysis (e.g., mode analysis) to determine the most frequently selected source window size.

At step 1106, the computer system can use any appropriate means to set the initial target window size. In some embodiments, the initial target window size can be set to a random value. Alternatively, as with the initial source window size, the initial target window size can be set using a most commonly selected target window size during training. Unlike the source window size, which may be fixed, the target window size may change with each iteration of the anomaly detection method.

At step 1108, the computer system can sample one or more source time series data values xₜ from the source data set X using the initial source window size and based on a time value t. As described above, the computer system can sample “backwards” from a source data value defined by the time value t based on the window size. For example if the time value t=10, and the window size n=4, the one or more source time series data values xₜ can comprise xₜ=(x₇, x₈, x₉, x₁₀). Likewise at step 1108, the computer system can sample one or more target time series data values \hat{x}ₜ from the target data set \hat{X} using the initial target window size and based on the time value t. The same “backwards” sampling procedure, described above, can be used to sample the one or more target time series data values \hat{x}ₜ from the target data set \hat{X}.

Typically, the method according to FIG. 11 involves iterating through the entire target data set \hat{X} for the purpose of classifying all target time series data values \hat{x}ₜ . Typically, this can be performed sequentially, starting at the first time value (t=1, or sometimes t=0) and proceeding sequentially (t=2, t=3, etc.) until all target time series data values \hat{x}ₜ have been classified. In such a case, particularly for low values of t, the computer system may use “wrap-around” sampling, as described above, to sample from the source data set X and the target data set \hat{X} in step 1108. For example, assuming a source data set X comprising 100 source time series data values (x₁, . . . , x₁₀₀), a time value t=1, and a window size n=6, the one or more source time series data values xₜ could comprise (x₉₆, x₉₇, x₉₈, x₉₉, x₁₀₀, x₁). Wrap around sampling can also be used to sample the one or more target data values \hat{x}ₜ if necessary.

After sampling the one or more initial source time series data values xₜ and the one or more initial target time series data values \hat{x}ₜ , the computer system can provide the one or more initial source time series data values xₜ and the one or more initial target time series data values \hat{x}ₜ to a trained anomaly detector in order to determine whether a target data value corresponding to the one or more initial target time series data values \hat{x}ₜ comprises an anomalous data value. This process, roughly corresponding to steps 1110-1118, is described in further detail below.

At step 1110, the computer system can generate a source encoding ε(xₜ) using a trained encoder ε (which can comprise part of an LSTM autoencoder trained during the training phase) and the one or more initial source time series data values xₜ. Likewise, at step 1110, the computer system can generate a target encoding ε(xₜ) using the trained encoder ε and the one or more initial target time series data values \hat{x}ₜ . In some embodiments, the source encoding ε(xₜ) and target encoding ε(\hat{x}ₜ) may be the same length, e.g., comprise the same amount of data.

At step 1112, the computer system can generate a target classification [symbol] (ε(\hat{x}ₜ)) using the target encoding ε(\hat{x}ₜ) and a trained classifier component [symbol] of the anomaly detector. The classifier [symbol] may comprise a multi-layer perceptron classifier with sigmoid activation function, used to produce a target classification [symbol] (ε(\hat{x}ₜ)) that classifies the target encoding ε(xₜ) (and by extension the one or more target time series data values \hat{x}ₜ) as corresponding to a normal target data value or an anomalous target data value. The target classification [symbol] (ε(\hat{x}ₜ)) may be used with a target reconstruction [symbol] (ε(\hat{x}ₜ)) (described below) in order to calculate an anomaly score A(\hat{x}ₜ), e.g., at step 1118.

At step 1114, the computer system can generate a target reconstruction [symbol] (ε(\hat{x}ₜ)) using the target encoding ε(\hat{x}ₜ) and a trained decoder component [symbol] (which can comprise part of an LSTM autoencoder trained during the training phase). Provided that the decoder [symbol] is well trained, the target reconstruction [symbol] (ε(\hat{x}ₜ)) can comprise data similar to the one or more target time series data values \hat{x}ₜ used to generate the target encoding ε(\hat{x}ₜ). The target reconstruction [symbol] (ε(\hat{x}ₜ)) can be used to produce a target reconstruction loss value [symbol] _{recon} which can be used along with the target classification [symbol] (ε(\hat{x}ₜ)) to generate an anomaly score A(\hat{x}ₜ).

At step 1116, the computer system can generate a target reconstruction loss value [symbol] _{recon} using the one or more target time series data values \hat{x}ₜ and the target reconstruction [symbol] (ε(\hat{x}ₜ)). The computer system can use a loss and reward calculator component (e.g., as described in FIGS. 9 and 10) to calculate the target reconstruction loss value [symbol] _{recon}. In some embodiments, the computer system can calculate the target reconstruction loss value [symbol] _{recon} using the formula: [symbol] _{recon}=∥\hat{x}ₜ− [symbol] (ε(\hat{x}ₜ))∥₂².

At step 1118, the computer system can generate an anomaly score A(\hat{x}ₜ) using the target classification [symbol] (ε(\hat{x}ₜ)) generated at step 1112 and the target reconstruction loss value [symbol] _{recon} generated at step 1116. In some embodiments, the computer system can generate the anomaly score A(\hat{x}ₜ) by calculating the product of the target classification [symbol] (ε(\hat{x}ₜ)) and the target reconstruction loss value [symbol] _{recon}, i.e., A(\hat{x}ₜ)= [symbol] (ε(\hat{x}ₜ))· [symbol] _{recon}= [symbol] (ε(\hat{x}ₜ))·∥\hat{x}ₜ− [symbol] (ε(\hat{x}ₜ))∥₂².

The anomaly score A(\hat{x}ₜ) may comprise a value that indicates the probability that a target data value corresponding to (or represented by) the one or more target time series data values \hat{x}ₜ and the time value t is an anomaly. For example, an anomaly score A(\hat{x}ₜ)=0.8 may indicate that there is an 80% chance that the target data value corresponding to the one or more target time series data values \hat{x}ₜ is an anomalous data value. In some cases, it may be desirable to have a precise (often binary) classification or label indicating whether a target data value is normal or anomalous. As such, in some embodiments, the computer system can compare the anomaly score A(\hat{x}ₜ) to an anomaly score threshold. If the anomaly score A(\hat{x}ₜ) is greater than the anomaly score threshold, the computer system can determine that the target time series data value corresponding to the one or more target time series data value \hat{x}ₜ comprises an anomalous data value.

Having generated an anomaly score A(\hat{x}ₜ) (and optionally a label or binary classification) corresponding to a target time series data value, classification of that target time series data value is effectively complete. However, in order to classify any subsequent target time series data values, the computer system may generate a subsequent source window size and a subsequent target window size using the trained context sampler. The subsequent source window size and subsequent target window size can be used to sample one or more subsequent source time series data values xₜ₊₁ and one or more subsequent target time series data values \hat{x}ₜ₊₁ , which can be used to classify a subsequent target time series data value corresponding to a subsequent time value (e.g., t+1) as normal or anomalous.

At step 1120, the computer system can generate a state value sₜ using the encoder ε, the one or more source time series data values xₜ and the one or more target time series data values \hat{x}ₜ. More specifically, the computer system can use the source encoding ε(xₜ) and target encoding ε(\hat{x}ₜ) generated at step 1110 to generate the state value sₜ. In some embodiments, the state value sₜ can comprise a concatenation of the source encoding ε(xₜ) and the target encoding ε(\hat{x}ₜ), i.e., sₜ=(ε(xₜ), ε(\hat{x}ₜ)).

At step 1122, the computer system can generate an action aₜ comprising a subsequent source window size and a subsequent target window size using the trained context sampler and the state value sₜ. As stated above, the subsequent source window size and subsequent target window size can be used to determine whether a subsequent target time series data value (e.g., corresponding to one or more subsequent time series data values \hat{x}ₜ₊₁) corresponding to a subsequent time value t+1 comprises an anomalous data value. The computer system can generate the action aₜ by inputting the state value sₜ into a trained policy function \tilde{π}(sₜ) associated with (or implemented by) the trained context sampler component. In some embodiments, the source window size may be fixed, and as such, the subsequent source window size may be equal to the initial source window size.

At step 1124 the computer system can advance to a subsequent target time series data value in order to classify that target time series data value. This advancement may comprise advancing the time values t associated with the target time series data values. For example, if at step 1118, the computer system generated an anomaly score for a target time series data value corresponding to a time value t=1, the computer system can advance to a target time series data value corresponding to time value t=2. The computer system can then return to step 1108, and sample one or more subsequent source time series data values xₜ₊₁ and one or more subsequent target time series data values \hat{x}ₜ₊₁. Steps 1108-1124 can be repeated until an anomaly score A(\hat{x}ₜ), classification, or label, has been generated for some or all of the target time series data values.

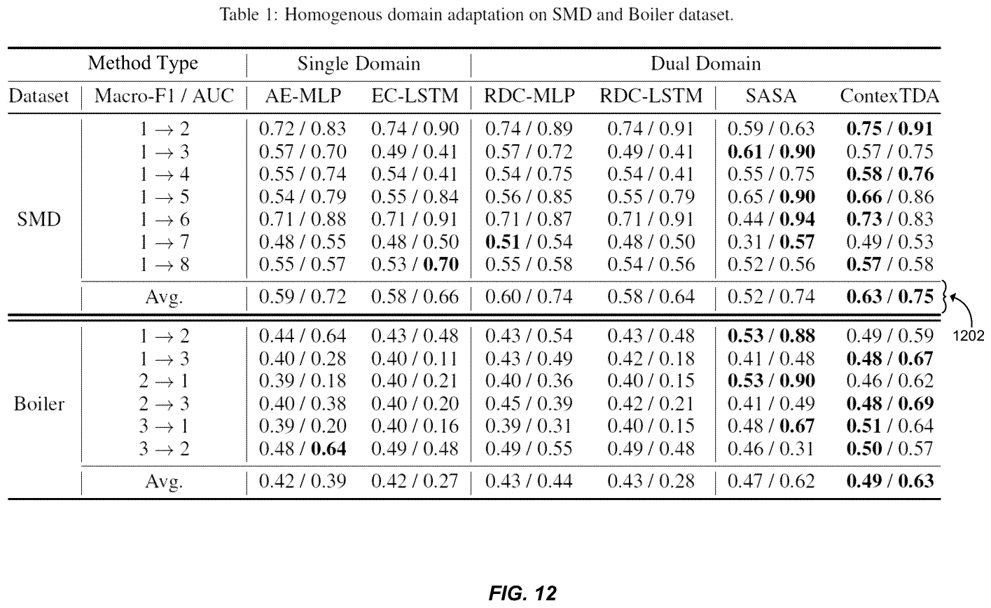

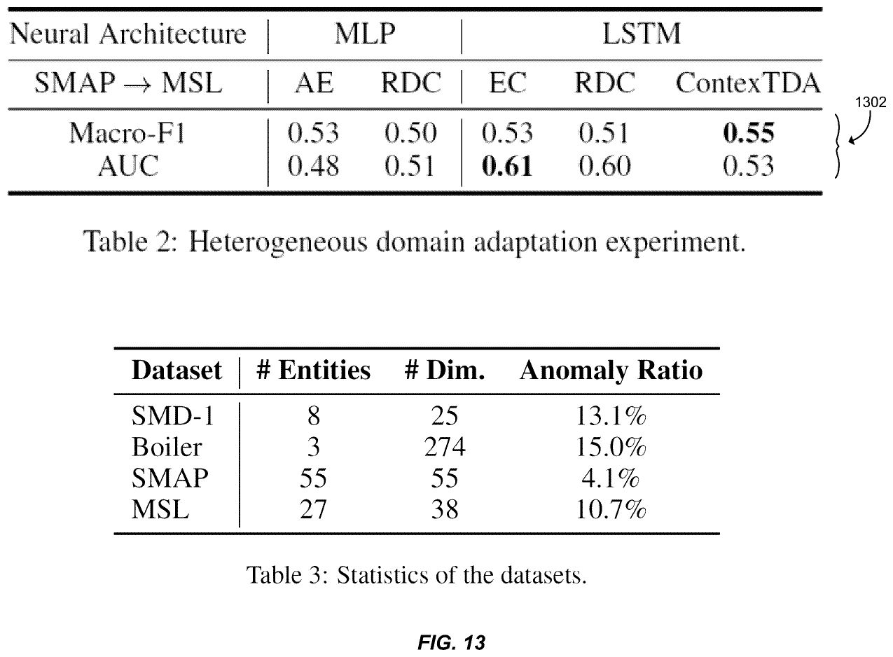

Some experiments were performed using an implementation of some embodiments of the present disclosure. These experiments are described below with reference to FIGS. 12 and 13. Generally, these experiments focused on comparing embodiments of the present disclosure against existing time series anomaly detection and domain adaptation methods, in both the homogeneous setting (i.e., in which the source and target domains are similar) and the heterogeneous setting (i.e., in which the source and target domains are different). In the homogeneous setting, the source and target domains may have identical data characteristics. As an example, a source data vector and a target data vector, both corresponding to health data, could both comprise data values for height, weight, and age. By contrast, in a heterogeneous setting, the source data vector and the target data value may have different data characteristics. For example, the source data vector could comprise data values corresponding to height, weight, and age, and the target data vector could comprise data values for blood pressure, gender, and cholesterol levels.

Four data sets were used to evaluate embodiments of the present disclosure in the homogeneous and heterogeneous setting. In the homogeneous setting, the Server Machine Dataset (SMD) Dataset and Boiler data set were used ([Su et al., In Proceedings of the 25th ACM SIGKDD International Conference on Knowledge Discovery & Data Mining, pages 2828-2837, 2019] and [Cai et al., arXiv preprint arXiv: 2012.11797, 2020], respectively). In the heterogeneous setting, the MSL and SMAP data sets were used [Hundman et al., In Proceedings of the 24th ACM SIGKDD international conference on knowledge discovery & data mining, pages 387-395, 2018].

The first subset of the SMD data set was used to perform the homogeneous experiment. Data corresponding to the first machine was used to represent the source domain, while data corresponding to all other machines were used to represent the target domains. With regards to homogeneous experiments using the boiler dataset, all pairwise combinations of all three machines were used. In the heterogeneous experiment, SMAP was used as the source data set and MSL was used as the target data set. Both data sets were subject to some baseline modifications to fit the heterogeneous experiment.

As stated above, these experiments compared embodiments of the present disclosure (also referred to as ContexTDA) against existing anomaly detection models. More specifically, these experiments compare embodiments of the present disclosure against both single-domain and dual-domain anomaly detector models. The dual-domain models inherited the neural architecture of the single-domain models, in order to study the effectiveness of domain knowledge transfer. All of the single-domain and dual-domain models were trained and tested on the target domain using unsupervised machine learning techniques. More specifically, the single-domain baselines were trained without any information from the source domain, whereas the dual-domain models were trained using both the source domain data and corresponding source domain data labels.

The used single-domain and duel-domain models include the following: AE-MLP [Sakurada and Yairi, In Proceedings of the MLSDA 2014 2nd Workshop on Machine Learning for Sensory Data Analysis, pages 4-11, 2014] is a single-domain baseline, which is an 256-128-128-256 fully-connected autoencoder. AE-MLP is as a common baseline for time series outlier detection. EC-LSTM [Malhotra et al., arXiv preprint arXiv: 1607.00148, 2016] is a single-domain baseline, which is an encoder-decoder with 256-128-128-256 LSTM units. EC-LSTM is as an advanced baseline for time series outlier detection. RDC [Tzeng et al., arXiv preprint arXiv: 1412.3474, 2014] is a dual-domain model which aligns the two domains with MMD and leverages label information by performing source domain classification with latent representations. Multi-layer perceptron and LSTM units with the same neural architecture as AE and EC were used to develop corresponding baselines (i.e., RDC-MLP and RDC-LSTM). SASA [Cai et al., arXiv preprint arXiv: 2012.11797, 2020] is a dual-domain model which exploits a self-attention layer with LSTM units to identify the optimal global context window size for the source and target domain and can align the two domains using MMD.

In more detail, the Server Machine Dataset (SMD) is a 5-week long data set corresponding to servers operated by a large internet company. SMD is divided into three subsets. The first subset, corresponding to eight servers, was used to perform the homogeneous experiments. The first server was used to represent the source domain and the remaining seven servers were used to represent the target domain in the domain adaptation experiment. Broadly, the goal of the homogeneous experiment was to detect anomalies in the data set corresponding to the seven target domain servers by adapting information corresponding to the single source domain server.

In more detail, “Boiler” is a sensor dataset collected from three boilers between 2014 Mar. 24 and 2016 Nov. 30. Data corresponding to all three boilers was used in the experiments. Domain adaptation was performed on all pairwise combinations of these boilers. In the boiler experiments, anomalies comprise system faults of the boilers.

The Mars Science Laboratory rover (MLS) and Soil Moisture Active Passive satellite (SMAP) datasets comprise real spacecraft telemetry data collected from NASA. These datasets were adopted for heterogeneous transfer, since the two datasets are similar, but comprise a different number of data dimensions.

The publicly available preprocessing script provided by [Su et al., 2019] (https://github.com/NetManAIOps/OmniAnomaly/blob/master/data_preprocess.py) was used to preprocess the SMAP, MSL, and SMD datasets. For the Boiler dataset, the preprocessed dataset provided on the GitHub repository of [Cai et al., 2020] (https://github.com/DMIRLAB-Group/SASA/tree/main/datasets/Boiler) was used. The detailed data statistics corresponding to these data sets are presented in Table 3 in FIG. 13.

For single-domain baselines, publicly available code from the GitHub repository of [Malhotra et al., 2016] (https://github.com/PyLink88/Recurrent-Autoencoder) was used for the EC-LSTM. PyOD (https://github.com/yzhao062/pyod/) was used to implement AE-MLP. The neural architectures for both baselines were 256-128-128-256 with different types of neural units.

For dual-domain baselines, the framework of a publicly available GitHub repository (https://github.com/syorami/DDC-transfer-learning) was used, and the underlying neural architecture was modified based on the single domain baselines for anomaly detection. For SASA, the implementation of a publicly available GitHub repository (https://github.com/DMIRLAB-Group/SASA) was used, and the neural architecture of the LSTM unions and source domain classifier were unified.

All machine learning models were trained with a training epoch T=5, and a batch size of 128. Learning rates for the machine learning models were selected from {0.050.10.150.20.25}. The contamination ratios for the machine learning models were selected from {0.050.10.150.20.250.3}.

A system according to embodiments, used to evaluate the performance of methods according to embodiments, was implemented based on the baseline RDC-LSTM, which was developed based on the implementation of EC-LSTM [Malhotra et al., 2016]. Specifically, in addition to MMD, the system according to embodiments used two 128-128 MLP classifiers with dropout ratio 0.2 and sigmoid activation functions, one for 10 leveraging source domain label information using the classification loss [symbol] _{cls} and another for generating domain invariant features using the domain discrimination loss [symbol] _{disc}. The open-source RLCard package was used to implement the deep Q-learning based context sampler, used to select source and domain window sizes by leveraging the hidden features generated by the encoder ε of the anomaly detector (i.e., the source encoding ε(xₜ) and the target encoding ε(\hat{x}ₜ)).

A pseudocode representation of an exemplary training method according to embodiments, used during these experiments, is presented in FIG. 8. A 256-128-64 MLP was used for the Q-function and ϵ was set to 0.2. The size of the memory buffer was set to 10000 and the sampling batch size for training the DQN was set to 32.

In the experiments, Macro-F1 scores and AUC (area under the curve) scores were used to evaluate the models. These scores are based off the identification of true positives, true negatives, false positives, and false negatives with regards to anomalies. A true positive can comprise, e.g., an anomalous data value that was correctly identified as anomalous. A true negative can comprise a normal data value that is correctly identified as normal. A false positive can comprise a normal data value that is incorrectly identified as an anomaly. A false negative can comprise an anomaly that is identified as a normal data value. Evaluating the number of true and false positives and negatives can be used to generally summarize the performance of a machine learning model. Macro-F1 and AUC are two metrics that use these true and false positive numbers to evaluate performance.

The Macro-F1 score can comprise a ratio of the true positives to a linear combination of true positives, false positives and false negatives. Generally, the Macro-F1 score increases as true positives increase, and increases as false positives and false negatives decrease. A high Macro-F1 score is then generally associated with a high true positive rate and a low false positive and false negative rate. The AUC score generally comprises the area under a “receiver operating characteristics curve,” a curve that relates the true positive rate to the false positive rate for different anomaly thresholds. The AUC score generally increases as the true positive rate increase, and increases as the false positive rate decreases. A high AUC score is often associated with a high true positive rate and a low false positive rate.

One goal of the homogeneous transfer experiments was to study the differences between different domain adaptation methods while comparing them with their parent single-domain models. By comparing each child dual domain model with its corresponding parent single domain model, the effectiveness of individual methodologies can be evaluated. Table 1 in FIG. 12 summarizes the result of the homogeneous transfer experiment. As indicated by indicator 1202, embodiments of the present disclosure (ContexTDA) advantageously outperformed most baselines on average. As shown in Table 1, the dual domain SASA model achieved an average Macro-F1 score of 0.52 and an average AUC score of 0.74. By contrast, embodiments (ContextTDA) achieved a Macro-F1 score of 0.63 and an AUC score of 0.75, an 0.11 improvement in Macro-F1 and a 0.01 improvement in AUC. This indicates that embodiments of the present disclosure achieve a higher true positive rate and/or a lower false positive and false negative rate than conventional machine learning models. Based on the heterogeneous experiment, the following observations can be made.

First, performing domain adaptation using the same source window size and target window size may not be useful in anomaly detection applications. Although, it can be observed that the AUC scores of two RDC baselines are slightly better than the two single-domain baselines, there are no general improvements on Macro-F1 score. This suggests that forcefully transferring domain knowledge without carefully sample the contextual information may ignore label information corresponding to anomalous data values

Second, globally aligning the context window size for the source domain and the target domain leads to a model that favors normal data points. Observing the relationship between Macro-F1 and AUC scores of SASA across all settings, it appears that the AUC scores of SASA are generally higher than other baselines while the Macro-F1 scores are not. This indicates that the model performs better on identifying normal data points and therefore lead to worse Macro-F1 score.

Third, locally aligning the context size for domain adaptation facilitates the precise knowledge transfer on both anomalous and normal data values. In FIG. 12, as indicated by indicator 1202, embodiments of the present disclosure achieve superior macro-F1 scores, showing that embodiments outperform all other baselines with regards to detecting anomalous data values. In addition, since the underlying structure of embodiments is similar to SASA, it appears that domain adaptation on time series data is improved by local context window size alignment.

Heterogeneous transfer experiments are not well studied in existing work, as such, one goal of the heterogeneous transfer experiments was to study the capabilities of embodiments of the present disclosure in this setting. To create baselines, the RDF framework was extended from one MLP/LSTM system to two different MLP/LSTM systems, and the latent representation for these two domains was mapped into the same dimension in order to minimize MMD. Because SASA was not designed for this setting, it was not used as a baseline. The results of the heterogeneous transfer experiment are summarized in Table 2 in FIG. 13. As indicated by indicator 1302, embodiments of the present disclosure outperformed baselines with respect to Macro-F1 scores. Based on Table 2, the following observations can be made.

First, forcefully aligning two domains with different data characteristics can reduce the effectiveness of anomaly detection methods. By comparing the EC-LSTM with the RDC-LSTM and comparing the AE-MLP with the RDC-MLP, it appears that anomaly detection performance on the target domain is worse as a result of forceful domain alignment. Further, this phenomena is consistently demonstrated across different neural architectures. This suggests that using the same context window size for the source domain and the target domain is sub-optimal and therefore leads to negative knowledge transfer.

Second, locally aligning the context window size facilitates domain knowledge transfers for two heterogeneous domains. As indicated in FIG. 12, the Macro-F1 score of embodiments of the present disclosure is greater than Macro-F1 score of the EC-LSTM, while the Macro-F1 score of the RDC-LSTM is less than the Macro-F1 score of the EC-LSTM. This suggests that the heterogeneous domain knowledge transfer has a greater effect on anomaly detection than detecting normal data values.

In conclusion, some embodiments of the present disclosure are directed to a time series domain adaptation system, sometimes referred to as “ContexTDA.” Embodiments of the present disclosure can adaptively determine source window sizes and target window sizes used to sample source time series data values and target time series data values respectively, in order to classify unlabeled target time series data values as normal or anomalous. Embodiments of the present disclosure formulate the context sampling problem as a Markov decision process and use a tailored deep reinforcement learning method to facilitate time series domain adaptation. The homogeneous experiments described above empirically show that embodiments of the present disclosure outperform several baselines, including state-of-the-art techniques for domain adaptation. The homogeneous experiments show that aligning context window size for data values corresponding to heterogeneous domains may be useful in performing heterogeneous domain knowledge transfer.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method comprising:
a) generating, by a computer system, an initial source window size and an initial target window size;
b) sampling, by the computer system, one or more initial source time series data values and one or more initial target time series data values using the initial source window size and the initial target window size;
c) generating, by the computer system, a state value using the one or more initial source time series data values and the one or more initial target time series data values; and
d) for each time value up to a training epoch value, performing at least the following steps:
(i) generating, by the computer system, using a context sampler, an action comprising a source window size and a target window size based on the state value;
(ii) sampling, by the computer system, one or more source time series data values based on the source window size and the time value;
(iii) sampling, by the computer system, one or more target time series data values based on the target window size and the time value;
(iv) updating, by the computer system, the state value to an updated state value using the one or more source time series data values and the one or more target time series data values;
(v) computing, by the computer system, a reward value using the one or more source time series data values, and the one or more target time series data values;
(vi) storing, by the computer system, a tuple including the state value, the action comprising the source window size and the target window size, the updated state value, and the reward value in a memory buffer of the context sampler; and
(vii) training, by the computer system, the context sampler in an iterative process using sampled data comprising at least the tuple from the memory buffer of the context sampler.

2. The method of claim 1, further comprising:
after step (vii), (viii) recording, by the computer system, each source window size, thereby recording a plurality of source window sizes proportional to the training epoch value; and
after step d), e) determining, by the computer system, a frequently selected source window size based on the plurality of source window sizes, wherein the frequently selected source window size is used during an anomaly detection process.

3. The method of claim 1, wherein the method further comprises after d):
inputting source data values and target data values into the trained context sampler, which outputs source time series data values and target time series data values to an anomaly detector, which determines one or more anomalies in the target time series data values.

4. The method of claim 3, wherein the reward value is computed using one or more loss values comprising a classification loss value, a reconstruction loss value, an alignment loss value, and a domain discrimination loss value, and wherein the method further comprises computing the one or more loss values.

5. The method of claim 4, wherein the reward value is computed using a classification hyper-parameter, a reconstruction hyper-parameter, an alignment hyper-parameter, and a domain discrimination hyper-parameter.

6. The method of claim 4, wherein the anomaly detector comprises an encoder, a decoder, a classifier, and a domain classifier, and wherein:
the classification loss value is computed using the classifier, the encoder, the one or more source time series data values, one or more labels corresponding to the one or more source time series data values, and one or more weights corresponding to the one or more source time series data values;
the reconstruction loss value is calculated using the encoder, the decoder, the one or more source time series data values, and the one or more target time series data values;
the alignment loss value is calculated using the encoder, the one or more source time series data values, and the one or more target time series data values; and
the domain discrimination loss value is calculated using the encoder, the domain classifier, the one or more source time series data values, the one or more target time series data values, and one or more domain labels.

7. The method of claim 6, further comprising:
training, by the computer system, the anomaly detector by training the encoder, the decoder, the classifier, and the domain classifier.

8. The method of claim 6, wherein:
the classifier comprises a multi-layer perceptron classifier with a sigmoid activation function;
the domain classifier comprises another multi-layer perceptron classifier with a sigmoid activation function; and
the encoder and the decoder comprise two parts of an LSTM autoencoder.

9. The method of claim 1, wherein:
the one or more initial source time series data values comprise a subsequence of a source data set, wherein a number of initial source time series data values in the subsequence of the source data set is proportional to the initial source window size;
the one or more initial target time series data values comprise a subsequence of a target data set, wherein a number of initial source time series data values in the subsequence of the target data set is proportional to the initial target window size;
the one or more source time series data values comprise a subsequence of the source data set, wherein a number of source time series data values in the subsequence of the source data set is proportional to the source window size; and
the one or more target time series data values comprise a subsequence of the target data set, wherein a number of target time series data values in the subsequence of the target data set is proportional to the target window size.

10. The method of claim 9, wherein a cyclical sampling process is used to sample the one or more initial source time series data values, the one or more initial target time series data values, the one or more source time series data values, and the one or more target time series data values.

11. A computer system comprising:
a processor; and
a non-transitory computer readable medium coupled to the processor, the non-transitory computer readable medium comprising code, executable by the processor, for performing a method comprising:
a) generating an initial source window size and an initial target window size;
b) sampling one or more initial source time series data values and one or more initial target time series data values using the initial source window size and the initial target window size;
c) generating a state value using the one or more initial source time series data values and the one or more initial target time series data values; and
d) for each time value up to a training epoch value, performing at least the following steps:
(i) generating using a context sampler, an action comprising a source window size and a target window size based on the state value;
(ii) sampling one or more source time series data values based on the source window size and the time value;
(iii) sampling one or more target time series data values based on the target window size and the time value;
(iv) updating the state value to an updated state value using the one or more source time series data values and the one or more target time series data values;
(v) computing a reward value using an anomaly detector, the one or more source time series data values, and the one or more target time series data;
(vi) storing a tuple including the state value, the action comprising the source window size and the target window size, the updated state value, and the reward value in a memory buffer of the context sampler; and
(vii) training the context sampler in an iterative process using sampled data comprising at least the tuple from the memory buffer of the context sampler.

12. The computer system of claim 11, wherein the state value comprises combination of a source encoding generated using the encoder and the one or more source time series data values and a target encoding generated using the encoder and the one or more target time series data values.

13. The computer system of claim 11, wherein the sampled data used to train the context sampler comprises the tuple and one or more previous tuples stored in the memory buffer.

14. The computer system of claim 11, wherein training the context sampler comprises optimizing a Q-function associated with the context sampler.

15. The computer system of claim 14, wherein:
optimizing the Q-function improves a quality of one or more actions comprising one or more source window sizes and one or more target window sizes generated by the context sampler, which in turn improves a quality of one or more encodings, one or more reconstructions, one or more classifications, and one or more domain classifications generated by the anomaly detector, thereby reducing one or more loss values computed by the anomaly detector, thereby increasing the reward value.

16. A method comprising:
obtaining, by a computer system, a source data set and a target data set, wherein the source data set comprises the plurality of source time series data values, and wherein the target data set comprises a plurality of target time series data values, wherein the plurality of source time series data values are labeled and the plurality of target time series data values are unlabeled;
setting, by the computer system, a source window size and a target window size using a trained context sampler;
sampling, by the computer system, one or more source time series data values from the source data set using the source window size and based on a time value;
sampling, by the computer system, one or more target time series data values from the target data set using the target window size and based on the time value;
providing, by the computer system, the one or more source time series data values and the one or more target time series data values to an anomaly detector; and
determining, by the computer system, using the anomaly detector, whether a target data value in the one or more target time series data values comprises an anomalous data value.

17. The method of claim 16, wherein determining, using the anomaly detector, whether the target data value comprises the anomalous data value comprises:
generating, by the computer system, a target encoding using an encoder and the target data value;
generating, by the computer system, a target classification using a classifier and the target encoding;
generating, by the computer system, a target reconstruction using a decoder and the target encoding;
generating, by the computer system, a reconstruction loss value using the target data value and the target reconstruction;
generating, by the computer system, an anomaly score using the target classification and the reconstruction loss value; and
comparing, by the computer system, the anomaly score to an anomaly score threshold, wherein if the anomaly score is greater than the anomaly score threshold, the computer system determines that the target data value comprises the anomalous data value.

18. The method of claim 16, further comprising:
a) generating, by the computer system, an initial source window size and an initial target window size;
b) sampling, by the computer system, one or more initial source time series data values and one or more initial target time series data values using the initial source window size and the initial target window size;
c) generating, by the computer system, a state value using the one or more initial source time series data values and the one or more initial target time series data values; and
d) for each time value up to a training epoch value, performing at least the following steps:
(i) generating, by the computer system, using a context sampler, an action comprising another source window size and another target window size based on the state value;
(ii) sampling, by the computer system, one or more additional source time series data values based on the another source window size and the time value;
(iii) sampling, by the computer system, one or more additional target time series data values based on the another target window size and the time value;
(iv) updating, by the computer system, the state value to an updated state value using the one or more additional source time series data values and the one or more additional target time series data values;
(v) computing, by the computer system, a reward value using the anomaly detector, the one or more additional source time series data values, and the one or more additional target time series data values;
(vi) storing, by the computer system, a tuple including the state value, the action comprising the another source window size and the another target window size, the updated state value, and the reward value in a memory buffer of the context sampler; and
(vii) training, by the computer system, the context sampler in an iterative process using sampled data comprising at least the tuple from the memory buffer of the context sampler.

19. The method of claim 16, further comprising:
generating, by the computer system, a state value using an encoder, the one or more source time series data values and the one or more target time series data values; and
generating, by the computer system, an action comprising a subsequent source window size and a subsequent target window size using a context sampler and the state value, wherein the subsequent source window size and subsequent target window size are used to determine whether a subsequent target time series data value corresponding to a subsequent time value comprises a subsequent anomalous data value.

20. The method of claim 19, wherein the subsequent source window size is equal to the initial source window size, and wherein the action comprising the subsequent source window size and the subsequent target window size are generated by inputting the state value into a trained policy function associated with the context sampler.
